(19) United States
(12) Patent Application Publication
(10) Pub. No.: US 2009/0147702 A1
(43) Pub. Date: Jun. 11, 2009

(54) Method and Apparatus for Forming and Configuring a Dynamic Network of Mobile Network Nodes

(76) Inventors: Milind M. Buddhikot, Manalapan, NJ (US); Thierry Etienne Klein, Fanwood, NJ (US); Harish Viswanathan, Morristown, NJ (US)

Correspondence Address: WALL & TONG, LLP/;ALCATEL-LUCENT USA INC., 595 SHREWSBURY AVENUE, SHREWSBURY, NJ, 07702, US

(21) Appl. No.: 11/953,426

(22) Filed: Dec. 10, 2007

(51) Int. Cl. H04L 12/28

(52) U.S. Cl. 370/255

(57) ABSTRACT

The invention includes methods for forming, configuring, and managing a dynamic wireless network. A dynamic wireless network may be formed from at least one wireless node. The dynamic wireless network uses a Role Assignment Protocol (RAP) adapted for assigning one or more roles to each of the at least one wireless node. The dynamic wireless network uses a Network Configuration Protocol (NCP) adapted for configuring each of the at least one node at least according to the assigned role(s). A dynamic wireless network may be modified in response to one or more conditions, such as a wireless node joining the dynamic wireless network, a wireless node leaving the dynamic wireless network, wireless nodes moving within the dynamic wireless network, and the like. A dynamic wireless network may be split into multiple dynamic wireless networks and, similarly, multiple dynamic wireless networks may merge to form one dynamic wireless network.

### FIELD OF THE INVENTION

The invention relates to the field of communication networks and, more specifically, to wireless networks.

### BACKGROUND OF THE INVENTION

Emergency response organizations increasingly depend on wireless communication technology to provide communication during emergencies. Disadvantageously, however, emergencies often result in damage to, or sometimes even destruction of, existing network infrastructure, thereby preventing communications between emergency personnel. In other words, the existing communications infrastructure lacks survivability. Furthermore, even if portions of the existing communications infrastructure do survive the emergency, the existing communications infrastructure may not be able to handle the increased traffic load typical during emergencies. Specifically, remaining portions of the existing communication infrastructure may be overloaded as emergency personnel, and the general public, attempt various types of communications. Such deficiencies became clear during the events of Sep. 11, 2001, and again during the events of Hurricane Katrina.

### SUMMARY OF THE INVENTION

Various deficiencies in the prior art are addressed through the present invention of methods and apparatuses for forming, configuring, and managing a dynamic wireless network. A dynamic wireless network may be formed from at least one wireless node. The dynamic wireless network uses a Role Assignment Protocol (RAP) adapted for assigning one or more roles to each of the at least one wireless node. The dynamic wireless network uses a Network Configuration Protocol (NCP) adapted for configuring each of the at least one node at least according to the assigned role(s). A dynamic wireless network may be modified in response to one or more conditions, such as a wireless node joining the dynamic wireless network, a wireless node leaving the dynamic wireless network, wireless nodes moving within the dynamic wireless network, and the like. A dynamic wireless network may be split into multiple dynamic wireless networks and, similarly, multiple dynamic wireless networks may merge to form one dynamic wireless network.

### BRIEF DESCRIPTION OF THE DRAWINGS

The teachings of the present invention can be readily understood by considering the following detailed description in conjunction with the accompanying drawings, in which:

FIG. 1 depicts a standalone 911-NOW communication network architecture that is independent of any existing network infrastructure;

FIG. 2 depicts an integrated 911-NOW communication network architecture that utilizes a 911-NOW mesh network and an existing network infrastructure;

FIG. 3 depicts a high-level block diagram of one embodiment of a 911-NOW node;

FIG. 4 depicts a high-level block diagram of a 911-NOW node adapted to support network formation and configuration functions of the present invention;

FIG. 5 depicts functions performed by a 911-NOW node in preparation for forming a 911-NOW network or joining a 911-NOW network;

FIG. 6 depicts an example scenario in which a 911-NOW node discovers a 911-NOW node in a non-equilibrium state;

FIG. 7 depicts an example scenario in which a 911-NOW node discovers a 911-NOW node operating in the SN role;

FIG. 8 depicts an example scenario in which a 911-NOW node discovers an anchored cluster of 911-NOW nodes;

FIG. 9 depicts an example scenario in which two or more anchored clusters discover each other;

FIG. 10 depicts an example scenario in which a 911-NOW node operating in the RN role leaves the 911-NOW network;

FIG. 11 depicts an example scenario in which a 911-NOW node operating in the SSN role leaves the 911-NOW network;

FIG. 12 depicts an example scenario in which a 911-NOW node operating in the PSN role leaves the 911-NOW network;

FIG. 13 depicts an example scenario in which a 911-NOW node operating in the GN role leaves the 911-NOW network;

FIG. 14 depicts an exemplary state diagram for a 911-NOW node;

FIG. 15 depicts a network lifecycle of a 911-NOW network supporting network formation and configuration functions of the present invention;

FIG. 16 depicts a method according to one embodiment of the present invention; and

FIG. 17 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

The present invention is described within the context of a rapidly deployable wireless network (denoted herein as a 911 network on wheels, i.e., 911-NOW network); however, the present invention is applicable to various other networks. A 911-NOW network is formed by placing a 911-NOW node(s) on a mobile platform(s) such that when the mobile platform(s) is dispatched to a network site, the 911-NOW node(s) provides a wireless communication network. As described herein, one or more 911-NOW nodes may be deployed to form a wireless network. The 911-NOW network may be a standalone wireless network that is independent of existing network infrastructure or an integrated wireless network that utilizes existing network infrastructure.

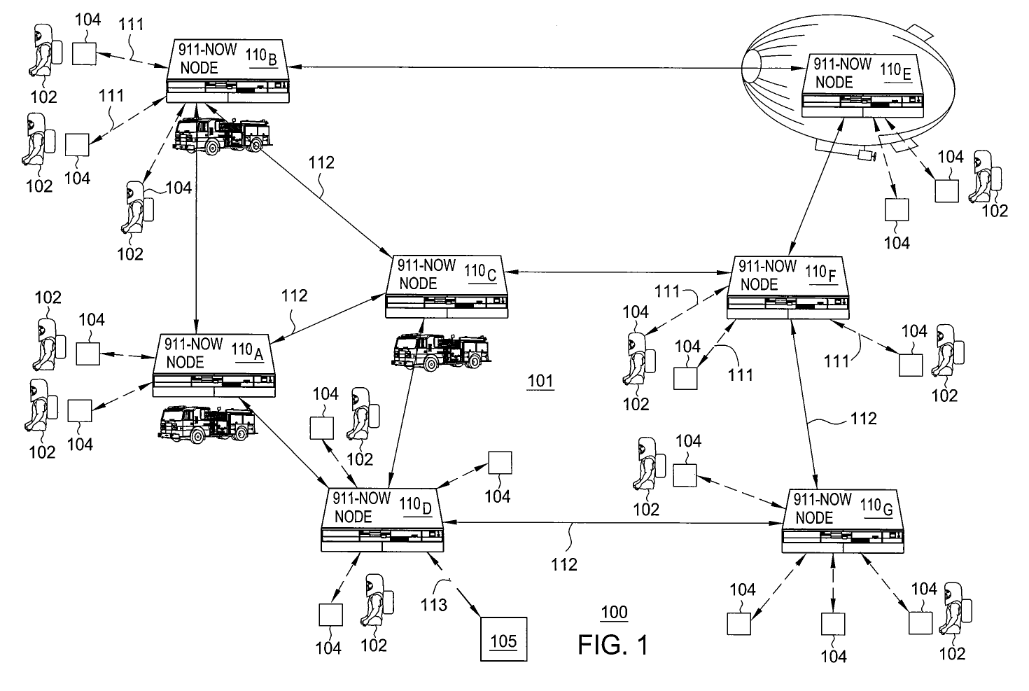

FIG. 1 depicts a standalone 911-NOW communication network architecture that is independent of any existing network infrastructure. Specifically, standalone 911-NOW communication network architecture 100 includes a plurality of 911-NOW nodes 100_{A}-100_{G} (collectively, 911-NOW nodes 110) supporting wireless communications at an emergency site 101. The standalone 911-NOW communication network architecture 100 provides a fully-functional network since each of the 911-NOW nodes 110 supports RAN functions, CORE networking functions, and services. As depicted in FIG. 1, each of the 911-NOW nodes 110 is placed or mounted on a mobile platform and transported to emergency site 101. The 911-NOW nodes 110 form a wireless network at emergency site 101.

The emergency site 101 may be any location or combination of locations at which a wireless network is required. The emergency site 101 may be a localized site, a collection of localized sites, a widespread site, a collection of widespread sites, and the like, as well as various combinations thereof. For example, emergency site 101 may be a single location, multiple locations within a town or city, or even span one or more counties, states, countries, or even continents. The 911-NOW network is not limited by the scope of the emergency site. The emergency site 101 may be associated with any type of emergency. For example, emergency site 101 may be associated with a natural disaster (e.g., a flood, a hurricane, a tornado, and the like), a manmade disaster (e.g., a chemical spill, a terrorist attack, and the like), and the like, as well as various combinations thereof.

As depicted in FIG. 1, emergency personnel (denoted herein as users 102 of the 911-NOW network 100) have responded to the emergency. The users 102 are performing various different functions at different areas of emergency site 101. For example, the users may be containing the disaster, participating in evacuation operations, participating in search and rescue operations, and the like, as well as various combinations thereof. The users 102 use equipment in responding to the emergency, including equipment capable of receiving and sending information wirelessly (denoted herein as wireless user devices 104 of users 102). The wireless user devices 104 include communication equipment, and may include various other types of emergency equipment (depending on the type of emergency, severity of the emergency, logistics of the emergency site, and various other factors).

For example, wireless user devices 104 may include wireless devices carried by emergency personnel for communicating with other emergency personnel, receiving information for use in responding at the emergency site, collecting information at the emergency site, monitoring conditions at the emergency site, and the like, as well as various combinations thereof. For example, wireless user devices 104 may include devices such as walkie-talkies, wireless headsets, cell phones, personal digital assistants (PDAs), laptops, and the like, as well as various combinations thereof. The wireless user devices 104 may include various other equipment, such as monitors (e.g., for monitoring breathing, pulse, and other characteristics; for monitoring temperature, precipitation, and other environmental characteristics; and the like), sensors (e.g., for detecting air-quality changes, presence of chemical or biological agents, radiation levels, and the like), and various other equipment.

As depicted in FIG. 1, a 911-NOW-based network is established at the emergency site 101 by deploying 911-NOW nodes 110 (illustratively, 911-NOW nodes 110_{A}-110_{G}) to emergency site 101. The 911-NOW nodes 110 may be deployed using mobile platforms. The 911-NOW nodes 110 may be deployed using standalone mobile platforms. For example, 911-NOW nodes 110 may be placed in backpacks, suitcases, and like mobile cases which may be carried by individuals. The 911-NOW nodes 110 may be deployed using mobile vehicles, including land-based vehicles, sea-based vehicles, and/or air-based vehicles. For example, 911-NOW nodes may be placed (and/or mounted) on police cars, swat trucks, fire engines, ambulances, humvees, boats, helicopters, blimps, airplanes, unmanned drones, satellites, and the like, as well as various combinations thereof. The 911-NOW nodes 110 may be deployed using various other mobile platforms.

As depicted in FIG. 1, 911-NOW node 110_{A} is deployed using a fire engine, 911-NOW node 110_{B} is deployed using a fire engine, 911-NOW node 110_{C} is deployed using a fire engine, 911-NOW node 110_{D} is deployed as a standalone node, 911-NOW node 110_{E} is deployed using a blimp, 911-NOW node 110_{F} is deployed as a standalone node, and 911-NOW node 110_{G} is deployed using a fire engine. The inherent mobility of 911-NOW nodes 110 enables quick and flexible deployment of a wireless network as needed (e.g., when, where, and how the wireless network is needed), thereby providing scalable capacity and coverage on-demand as required by the emergency personnel. Since each 911-NOW node 110 supports RAN functions, CORE networking functions, and various service functions, deployment of even one 911-NOW node produces a fully-functional wireless network.

As depicted in FIG. 1, the 911-NOW nodes 110 support wireless communications for wireless user devices 104 (denoted herein as wireless access communications). The wireless access communications include wireless communications between a 911-NOW node 110 and wireless user devices served by that 911-NOW node 110. A 911-NOW node 110 includes one or more wireless access interfaces supporting wireless communications for wireless user devices 104 using respective wireless access connections 111 established between wireless user devices 104 and 911-NOW nodes 110. The 911-NOW nodes 110 further support mobility of user devices 104 at emergency site 101 such that, as users 102 move around emergency site 101, communication sessions between wireless user devices 104 of those users 102 and 911-NOW nodes 110 are seamlessly transferred between 911-NOW nodes 110.

As depicted in FIG. 1, the 911-NOW nodes 110 support wireless communications between 911-NOW nodes 110 (denoted herein as wireless mesh communications). The wireless mesh communications include wireless communications between 911-NOW nodes, including information transported between wireless user devices 104, control information exchanged between 911-NOW nodes 110, and the like, as well as various combinations thereof. A 911-NOW node 110 includes one or more wireless mesh interfaces supporting wireless communications with one or more other 911-NOW nodes 110. The wireless mesh communications between 911-NOW nodes 110 are supported using wireless mesh connections 112 established between 911-NOW nodes 110.

As depicted in FIG. 1, the following pairs of 911-NOW nodes 110 communicate using respective wireless mesh connections 112: 911-NOW nodes 110_{A} and 110_{B}, 911-NOW nodes 110_{A} and 110_{C}, 911-NOW nodes 110_{A} and 110_{D}, 911-NOW nodes 110_{B} and 110_{C}, 911-NOW nodes 110_{C} and 110_{D}, 911-NOW nodes 110_{B} and 110_{E}, 911-NOW nodes 110_{C} and 110_{F}, 911-NOW nodes 110_{D} and 110_{G}, 911-NOW nodes 110_{E} and 110_{F}, and 911-NOW nodes 110_{F} and 110_{G}. As such, 911-NOW nodes 110 of FIG. 1 communicate to form a wireless mesh network. Although a specific wireless mesh configuration is depicted and described with respect to FIG. 1, 911-NOW nodes 110 may communicate to form various other wireless mesh configurations, and mesh configurations may be modified in real-time as conditions change.

As depicted in FIG. 1, the 911-NOW nodes 110 support wireless communications for one or more management devices 105 (denoted herein as wireless management communications). The wireless management communications include wireless communications between a 911-NOW node 110 and a management device(s) 105 served by that 911-NOW node 110. A 911-NOW node 110 includes one or more wireless management interfaces supporting wireless communications for management device(s) 105. The wireless management communications between management device 105 and 911-NOW node 110_{D} are supported using a wireless management connection 113 established between management device 105 and 911-NOW node 110_{D}.

The management device 105 is operable for configuring and controlling standalone 911-NOW network 100. For example, management device 105 may be used to configure and reconfigure one or more of the 911-NOW nodes 110, control access to the 911-NOW nodes, control functions and services supported by the 911-NOW nodes 110, upgrade 911-NOW nodes 110, perform element/network management functions for individual 911-NOW nodes or combinations of 911-NOW nodes (e.g., fault, performance, and like management functions) and the like, as well as various combinations thereof. The management device 105 may be implemented using existing devices (e.g., laptops, PDAs, and the like), or using a newly-designed device adapted to support such management functions. The management device 105 may connect to one or more 911-NOW nodes 110 directly and/or indirectly using wireline and/or wireless interfaces.

The 911-NOW nodes 110 support wireless communications using one or more wireless technologies. For wireless access communications, each 911-NOW node 110 may support one or more different wireless technologies, such as Global System for Mobile Communications (GSM), General Packet Radio Service (GPRS), Evolution—Data Optimized (1×EV-DO), Universal Mobile Telecommunications System (UMTS), High-Speed Downlink Packet Access (HSDPA), Worldwide Interoperability for Microwave Access (WiMAX), and the like. For wireless mesh communications, each 911-NOW node 110 may support Wireless Fidelity (WiFi) or WiMAX technology, microwave technologies, or any other wireless technology. For wireless management communications, each 911-NOW node 110 may support one or more such cellular technologies, and, further, may support WiFi technology, Bluetooth technology, or any other wireless technology.

The wireless communications supported by 911-NOW nodes 110 convey user information, control information, and the like, as well as various combinations thereof. For example, user information may include voice communications (e.g., voice calls, audio conferences, push-to-talk, and the like), data communications (e.g., text-based communications, high-speed data downloads/uploads, file transfers, and the like), video communications (e.g., video broadcasts, conferencing, and the like), multimedia communications, and the like, as well as various combinations thereof. The communications supported by 911-NOW nodes 110 may convey various combinations of content, e.g., audio, text, image, video, multimedia, and the like, as well as various combinations thereof. For example, control information may include network configuration information, network control information, management information and the like, as well as various combinations thereof. Thus, 911-NOW nodes 110 support wireless communication of any information.

Although a specific number of 911-NOW nodes 110 is depicted and described as being deployed to form a 911-NOW network, fewer or more 911-NOW nodes may be deployed to form a 911-NOW network supporting communications required to provide an effective emergency response. Similarly, although a specific configuration of 911-NOW nodes 110 is depicted and described as being deployed to form a 911-NOW network, 911-NOW nodes may be deployed in various other configurations (including different locations at one emergency site or across multiple emergency sites, different combinations of mesh connections between 911-NOW nodes, and the like, as well as various combinations thereof) to form a standalone 911-NOW network supporting RAN functions, CORE networking functions, and various services supporting multimedia communications to provide an effective emergency response.

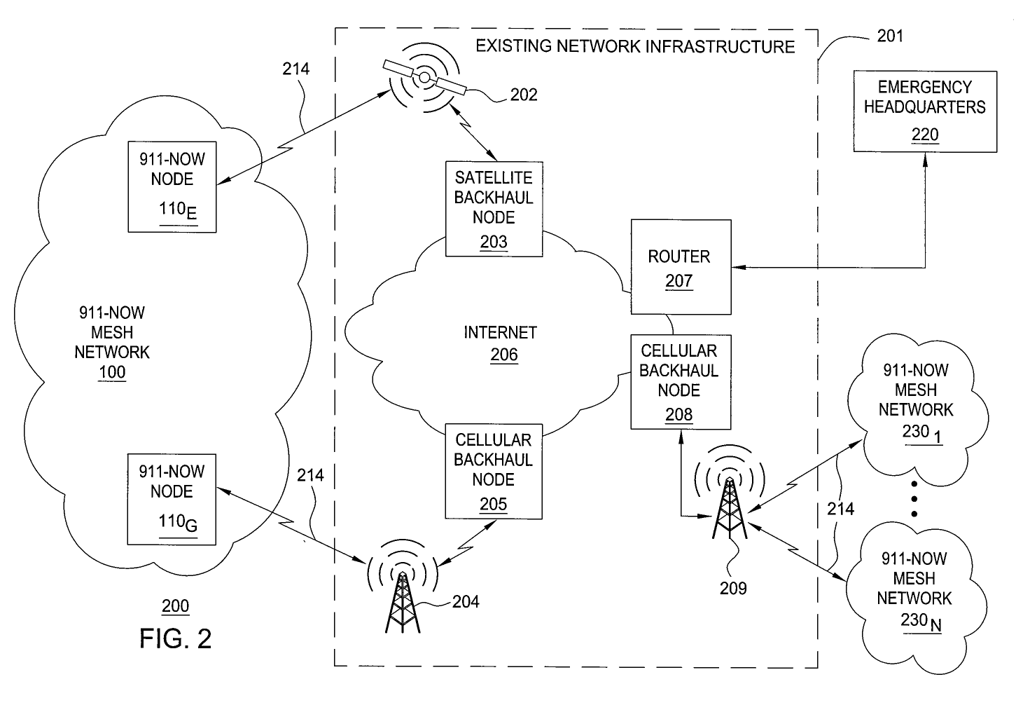

As described herein, although one or more 911-NOW nodes 110 are capable of forming a fully-functional standalone mesh wireless network without relying on existing infrastructure (fixed or variable), where there is existing infrastructure (that was not damaged or destroyed), the standalone 911-NOW wireless network may leverage the existing network infrastructure to form an integrated 911-NOW wireless network capable of supporting various additional capabilities (e.g., supporting communications with one or more other standalone 911-NOW wireless networks, supporting communications with one or more remote emergency management headquarters, supporting communications with other resources, and the like, as well as various combinations thereof). An integrated 911-NOW wireless network including a mesh 911-NOW network in communication with existing network infrastructure is depicted and described herein with respect to FIG. 2.

FIG. 2 depicts an integrated 911-NOW communication network architecture including a 911-NOW mesh network and an existing network infrastructure. Specifically, the integrated 911-NOW communication network architecture 200 includes 911-NOW mesh network 100 (depicted and described with respect to FIG. 1) and existing network infrastructure 201. The existing network infrastructure 201 may include any existing communications infrastructure adapted for supporting communications for 911-NOW mesh network 100 (e.g., including wireless communications capabilities, backhaul functions, networking functions, services, and the like, as well as various combinations thereof).

The existing network infrastructure 201 may include wireless access capabilities (e.g., radio access networks, satellite access networks, and the like, as well as various combinations thereof), backhaul capabilities (e.g., public and/or private, wireline and/or wireless, backhaul networks supporting mobility management functions, routing functions, and gateway functions, as well as various other related functions), core networking capabilities (e.g., AAA functions, DNS functions, DHCP functions, call/session control functions, and the like), services capabilities (e.g., application servers, media servers, and the like), and the like, as well as various combinations thereof. Since 911-NOW nodes 110 also supports such capabilities, in some embodiments at least a portion of these capabilities of existing network infrastructure 201 may only be relied upon when necessary.

As depicted in FIG. 2, the existing network infrastructure 201 supports wireless backhaul connections. Specifically, the existing network infrastructure 201 supports two wireless backhaul connections from 911-NOW mesh network 100. The existing network infrastructure 201 supports a first wireless backhaul connection 214 with 911-NOW node 110_{E} using a satellite 202, where satellite 202 is in wireless backhaul communication with a satellite backhaul node 203 at the edge of Internet 206. The existing network infrastructure 201 supports a second wireless backhaul connection 214 with 911-NOW node 110_{G} using a cellular base station 204, where cellular base station in 204 is in wireline backhaul communication with a cellular backhaul node 205 at the edge of Internet 206.

As depicted in FIG. 2, the existing network infrastructure 201 further supports other connections to other locations with which users 102 of emergency site 101 may communicate. The existing network infrastructure 201 includes a router 207 supporting communications for an emergency headquarters 220 (which may include, for example, emergency personnel and/or emergency systems). The existing network infrastructure 201 includes a cellular backhaul node 208 and an associated base station 209 supporting communications for one or more other 911-NOW mesh networks 230₁-230_{N} (i.e., one or more other standalone 911-NOW networks established at remote emergency sites).

The existing network infrastructure 201 supports communications for 911-NOW mesh network 100. The existing network infrastructure 201 may support communications between wireless user devices 104 of 911-NOW mesh network 100 (e.g., complementing wireless mesh communications between 911-NOW nodes 110 of the standalone 911-NOW network 100). The existing network infrastructure 201 may support communications between wireless user devices 104 of 911-NOW mesh network 100 and other emergency personnel and/or emergency systems. For example, existing network infrastructure 201 may support communications between wireless user devices 104 of 911-NOW mesh network 100 and an emergency headquarters 220, one or more other 911-NOW mesh networks 230 (e.g., at emergency sites remote from emergency site 101), and the like, as well as various combinations thereof.

As depicted in FIG. 2, in addition to supporting one or more wireless access interfaces, one or more wireless mesh interfaces, and one or more wireless management interfaces, 911-NOW nodes 110 support one or more wireless backhaul interfaces supporting communications between 911-NOW nodes 110 and existing network infrastructure (illustratively, existing network infrastructure 201). The wireless backhaul communications between 911-NOW nodes 110 and existing network infrastructure 201 are supported using wireless backhaul connections 214 established between 911-NOW nodes 110 and existing network infrastructure 201. The wireless backhaul connections 214 may be provided using one or more wireless technologies, such as GSM, GPRS, EV-DO, UMTS, HSDPA, WiFi, WiMAX, microwave, satellite, and the like, as well as various combinations thereof.

The mesh networking capabilities provided by 911-NOW nodes 110, in combination with backhaul networking capabilities provided by 911-NOW nodes 110 using wireless backhaul connections with the existing network infrastructure 201, enable communications between emergency personnel at one emergency site (e.g., between users connected to 911-NOW nodes 110 of a standalone 911-NOW mesh network), between emergency personnel at different emergency sites (e.g., between users connected to 911-NOW nodes 110 of different standalone wireless mesh networks), between emergency personnel at one or more emergency sites and emergency management personnel (e.g., users stationed at emergency headquarters 220), and the like, as well as various combinations thereof.

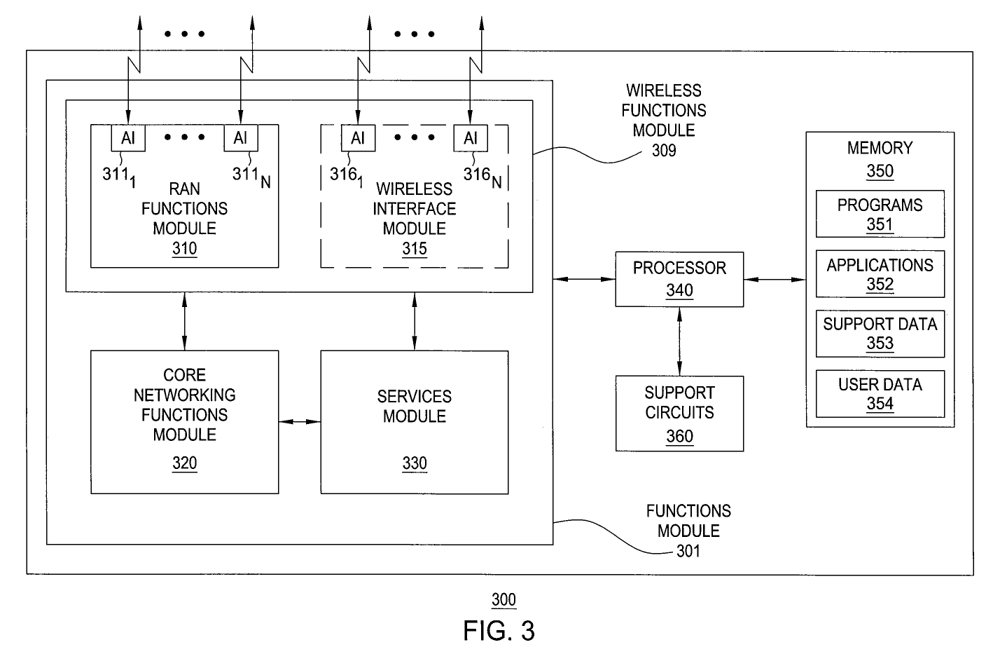

Thus, 911-NOW nodes 110 may each support four different types of wireless interfaces. The 911-NOW nodes 110 support one or more wireless access interfaces by which user devices 104 may access 911-NOW nodes 110. The 911-NOW nodes 110 support one or more wireless mesh interfaces by which 911-NOW nodes 110 communicate with other 911-NOW nodes 110. The 911-NOW nodes 110 support one or more wireless backhaul interfaces by which the 911-NOW nodes 110 communicate with existing network infrastructure. The 911-NOW nodes 110 support one or more wireless management interfaces by which network administrators may manage the 911-NOW-based wireless network. The functions of a 911-NOW node 110 may be better understood with respect to FIG. 3.

FIG. 3 depicts a high-level block diagram of one embodiment of a 911-NOW node. Specifically, as depicted in FIG. 3, 911-NOW node 110 includes a functions module 301, a processor 340, a memory 350, and support circuit(s) 360 (as well as various other processors, modules, storage devices, support circuits, and the like required to support various functions of 911-NOW node 110). The functions module 301 cooperates with processor 340, memory 350, and support circuits 360 to provide various functions of 911-NOW node 110, as depicted and described herein).

The processor 340 controls the operation of 911-NOW node 110, including communications between functions module 301, memory 350, and support circuit(s) 360. The memory 350 includes programs 351, applications 352, support data 353 (e.g., user profiles, quality-of-service profiles, and the like, as well as various combinations thereof), and user data 354 (e.g., any information intended for communication to/from user devices associated with 911-NOW node 110). The memory 350 may store other types of information. The support circuit(s) 360 may include any circuits or modules adapted for supporting functions of 911-NOW node 110, such as power supplies, power amplifiers, transceivers, encoders, decoders, and the like, as well as various combinations thereof.

The functions module 301 includes a wireless functions module 309, a core (CORE) networking functions module 320, and a services module 330. The wireless functions module 309 includes a radio access network (RAN) functions module 310 and, optionally, a wireless interface module 315. The CORE networking functions module 320 provides CORE networking functions. The services module 330 provides one or more services. The RAN functions module 310 (and, when present, wireless interface module 315) communicate with both CORE networking functions module 320 and services module 330, and CORE networking functions module 320 and services module 330 communicate, to provide functions depicted and described herein.

The wireless functions module 309, CORE networking functions module 320, and services module 330 cooperate (in combination with processor 340, memory 350, and support circuits 360, and any other required modules, controllers, and the like, which are omitted for purposes of clarity) to provide a rapidly deployable wireless node which may form: (1) a single-node, standalone wireless network; (2) a multi-node, standalone wireless network (i.e., using wireless mesh connections between 911-NOW nodes); or (3) an integrated wireless network (i.e., using wireless backhaul connections between one or more 911-NOW nodes and existing network infrastructure and, optionally, using wireless mesh connections between 911-NOW nodes).

The RAN functions module 310 provides RAN functions. The RAN functions include supporting one or more wireless access interfaces for communications associated with wireless user devices. Specifically, RAN functions module 310 supports a plurality of air interfaces (Als) 311₁-311_{N} (collectively, Als 311). The Als 311 provide wireless access interfaces supporting communications associated with wireless user devices. For example, Als 311 may support functions typically provided by a base transceiver station (BTS).

The RAN functions module 310 provides control functions. The control functions may include any control functions typically performed by controllers in radio access networks. For example, the control functions may include functions such as admission control, power control, packet scheduling, load control, handover control, security functions, and the like, as well as various combinations thereof. For example, in one embodiment, the control functions may include functions typically performed by RAN network controllers (RNCs) or similar wireless network controllers.

The RAN functions module 310 provides network gateway functions. The network gateway functions may include any functions typically performed in order to bridge RAN and CORE networks, such as IP session management functions, mobility management functions, packet routing functions, and the like, as well as various combinations thereof. For example, where intended for use with CDMA2000-based wireless technology, the network gateway functions may include functions typically performed by a Packet Data Serving Node (PDSN). For example, where intended for use with GPRS-based and/or UMTS-based wireless technology, the network gateway functions may include functions typically performed by a combination of a GPRS Gateway Support Node (GGSN) and a Serving GPRS Support Node (SGSN).

In one embodiment, RAN functions module 310 may be implemented as a base station router (BSR). In one such embodiment, the BSR includes a base station (BS) or one or more modules providing BS functions, a radio network controller (RNC) or one or more modules providing RNC functions, and a network gateway (NG) or one or more modules providing NG functions. In such embodiments, RAN functions module 310 supports any functions typically supported by a base station router.

The wireless interface module 315 provides one or more wireless interfaces. The wireless interfaces provided by wireless interface module may include one or more of: (1) one or more wireless mesh interfaces supporting communications with other 911-NOW nodes; (2) one or more wireless backhaul interfaces supporting communications with existing network infrastructure; and/or (3) one or more wireless management interfaces supporting communications with one or more management devices. The wireless interface module 315 supports a plurality of air interfaces (Als) 316₁-316_{N} (collectively, Als 316), which provide wireless interfaces supporting communications associated with one or more of: one or more other 911-NOW nodes, existing network infrastructure, and one or more management devices.

In one embodiment, a 911-NOW node 110 is implemented without wireless interface module 315 (e.g., if the 911-NOW node 110 is not expected to require wireless mesh, backhaul, or management capabilities). In one embodiment, a 911-NOW node 110 includes a wireless interface module 315 supporting a subset of: one or more wireless mesh interfaces, one or more wireless backhaul interfaces, and one or more wireless management interfaces (i.e., the 911-NOW node is tailored depending on whether the 911-NOW node 110 will require wireless management, mesh, and/or backhaul capabilities). In one embodiment, a 911-NOW node 110 includes a wireless interface module 315 supporting each of: one or more wireless mesh interfaces, one or more wireless backhaul interfaces, and one or more wireless management interfaces (i.e., all types of wireless interfaces are available should the 911-NOW node 110 require such wireless capabilities).

The CORE networking functions module 320 provides networking functions typically available from the CORE network. For example, CORE networking functions module 320 may provide authentication, authorization, and accounting (AAA) functions, domain name system (DNS) functions, dynamic host configuration protocol (DHCP) functions, call/session control functions, and the like, as well as various combinations thereof. One skilled in the art knows which functions are typically available from the CORE network.

The services module 330 provides services. The services may include any services capable of being provided to wireless user devices. In one embodiment, for example, services module 330 may provide services typically provided by application servers, media servers, and the like, as well as various combinations thereof. For example, services may include one or more of voice services, voice conferencing services, data transfer services (e.g., high-speed data downloads/uploads, file transfers, sensor data transfers, and the like), video services, video conferencing services, multimedia services, multimedia conferencing services, push-to-talk services, instant messaging services, and the like, as well as various combinations thereof. One skilled in the art knows which services are typically available over RAN and CORE networks.

Although primarily depicted and described herein with respect to a specific configuration of a 911-NOW node including three modules providing wireless functions (including RAN functions and, optionally, additional wireless interfaces and associated interface functions), CORE networking functions, and services, respectively, 911-NOW nodes may be implemented using other configurations for providing wireless functions, CORE networking functions, and services. Similarly, although primarily depicted and described herein with respect to a specific configuration of a functions module providing specific wireless functions, CORE networking functions, and services, functions modules of 911-NOW nodes may be implemented using other configurations for providing wireless functions, CORE networking functions, and services.

Therefore, it is contemplated that at least a portion of the described functions may be distributed across the various functional modules in a different manner, may be provided using fewer functional modules, or may be provided using more functional modules. Furthermore, although primarily depicted and described with respect to specific wireless functions (including RAN functions and, optionally, one or more additional wireless interface functions), CORE networking functions, and services, it is contemplated that fewer or more wireless functions (including RAN functions, optionally, and one or more additional wireless interface functions), CORE networking functions, and/or services may be supported by a 911-NOW node. Thus, 911-NOW nodes are not intended to be limited by the example functional architectures depicted and described herein with respect to FIG. 3.

In emergency situations, emergency vehicles often arrive at and leave from emergency sites at different times, depending on the location from which the emergency vehicles are dispatched, the location of the emergency site, the role of the emergency vehicle at the emergency site, and like factors, as well as various combinations thereof. Furthermore, depending on the scope of the emergency, emergency vehicles from a neighboring jurisdiction(s) may be dispatched to assist in responding to the emergency. As such, an emergency vehicle may arrive at an emergency site and/or leave from an emergency site under various different conditions.

For example, an emergency vehicle may be the first vehicle to arrive at an emergency site, may arrive at an emergency site after other emergency vehicles have arrived (but before a network is formed and configured), may arrive at an emergency site after other emergency vehicles (and after a network has been formed), as well as before or after a formed network has been configured, or may arrive at the emergency site to find various other conditions. Similarly, for example, an emergency vehicle may leave an emergency site under various conditions (e.g., while the network to which the emergency vehicle belongs is formed and operational, after some or all of the other emergency vehicles have left the emergency site, and the like).

In such a dynamic environment, it is important to ensure that a network can be formed at the emergency site, that a network formed at the emergency site can be made operational (i.e., that the network is configured to provide any communications capabilities that may be required at the emergency site), and, once formed and configured, that the network can be maintained in an operational state under various conditions (e.g., when nodes of the network move at the emergency site, when nodes join and/or leave the network, in response to other conditions (e.g., in response to changes in link utilization, available capacity, and like conditions), and the like, as well as various combinations thereof).

Therefore, in order to ensure proper formation, configuration, and, ultimately, operation of a 911-NOW network, the present invention performs network formation and configuration functions adapted to form a 911-NOW network, to assign roles to 911-NOW nodes of the 911-NOW network, and to configure 911-NOW nodes of the 911-NOW network based on assigned roles. The network formation and configuration functions may be performed using a Role Assignment Protocol (RAP) and a Network Configuration Protocol (NCP), each of which may be better understood with respect to the following description. The dynamic formation of a 911-NOW network may include initial formation of a 911-NOW network or reformation of the 911-NOW network, which may be initiated periodically or in response to an event or events.

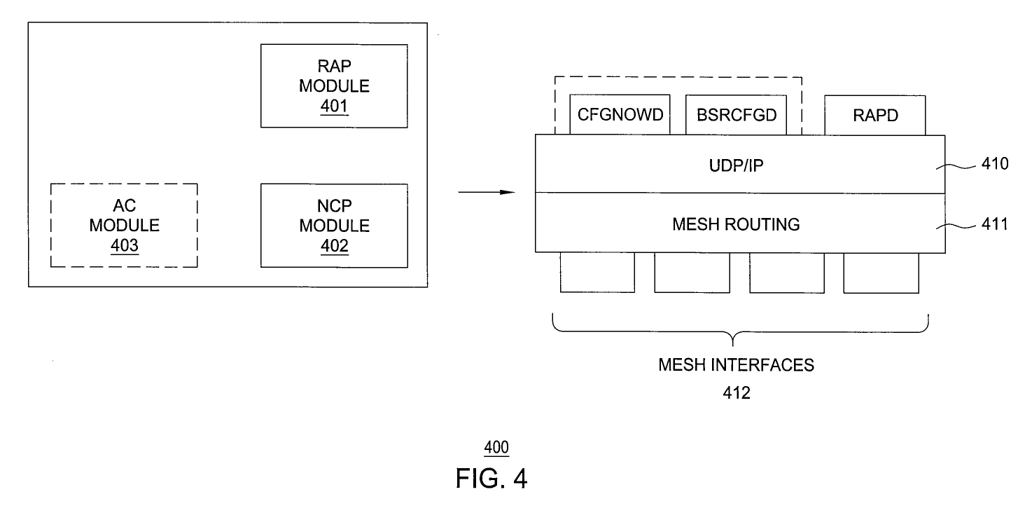

FIG. 4 depicts a high-level block diagram of a 911-NOW node adapted for supporting network formation and configuration functions of the present invention. Specifically, as depicted in FIG. 4, 911-NOW node 400 includes a Role Assignment Protocol (RAP) module 401 and a Network Configuration Protocol (NCP) module 402.

The RAP module 401 implements a Role Assignment Protocol (RAP), which is used to assign roles to each of the 911-NOW nodes of a 911-NOW network. The RAP module 401 may also be referred to herein as a RAP agent (which also may be denoted as a rapd agent).

The RAP protocol supports a set of defined roles. The RAP protocol is used to determine which role (or roles) to assign to each of the 911-NOW nodes of a 911-NOW network (i.e., each 911-NOW node may operate in one or more of the supported roles). The RAP protocol is used to assign the determined role(s) to each of the 911-NOW nodes of the 911-NOW network. The execution of the RAP protocol may be periodic or aperiodic. The RAP protocol may be implemented in a client-server fashion or in a distributed fashion.

In assigning roles to 911-NOW nodes of a 911-NOW network, the RAP protocol may evaluate available information (e.g., parameters of the 911-NOW network, parameters associated with 911-NOW nodes of the 911-NOW network, and the like, as well as various combinations thereof). For example, the RAP protocol may evaluate information such as network topology, quality of links between various node pairs, backhaul link connectivity from various nodes, node locations correlated with terrain maps, existing roles assigned to nodes (if any), and the like, as well as various combinations thereof.

A 911-NOW node of a 911-NOW network performs a set of functions and offers certain services within the 911-NOW network, where the functions performed and the services offered depend on the role (or roles) assigned to that 911-NOW node. The RAP protocol may support different numbers of roles and types of roles and, thus, 911-NOW nodes of different 911-NOW networks may support different sets of functions and provide different sets of services.

In one embodiment, for example, a 911-NOW network may support five different roles which may be assigned to 911-NOW nodes of the 911-NOW network, including: a Standalone Node (SN) role, a Relay Node (RN) role, a Primary Serving Node (PSN) role, a Secondary Serving Node (SSN) role, and a Gateway Node (GN) role. Although primarily depicted and described herein with respect to these roles, fewer or more roles (as well as different roles, or even similar roles having different definitions) may be supported by 911-NOW networks.

The assignment of a role (or, in some cases, roles) to a 911-NOW node may depend on various factors (e.g., how the roles are defined, the manner in which the roles are used, and the like). In one embodiment, at least some of the defined roles may be used in combination (e.g., multiple such roles can be assigned to a 911-NOW node at the same time). In one embodiment, at least some of the defined roles may be mutually exclusive from other defined roles (i.e., these roles cannot be assigned to a 911-NOW node at the same time). These permutations may be better understood with respect to the descriptions of the roles.

A 911-NOW node operating in the SN role does not participate in a network; rather, the 911-NOW node exists as a solitary network node. In this role, the 911-NOW node supports communications of user devices 104 via one or more access interfaces.

A 911-NOW node operating in the RN role operates as a relay node in a 911-NOW network. In this role, the access interface(s) of the 911-NOW node is active (supporting communications for user devices 104) and the mesh interface(s) of the 911-NOW node is active (enabling the 911-NOW node to participate in a mesh network with other 911-NOW nodes), but the backhaul interface(s) of the 911-NOW node is inactive.

A 911-NOW node operating in the PSN role operates as a RN and operates servers adapted to provide various services necessary for proper operation of the dynamic 911-NOW network. For example, a 911-NOW node operating as a PSN may operate a RADIUS server, a DIAMETER server, an Authentication, Authorization, and Accounting (AAA) server, a SIP conference server, and the like, as well as various combinations thereof.

A 911-NOW node operating in the SSN role operates as a RN and functions as a standby node for the 911-NOW node operating in the PSN role. The 911-NOW node operating in the SSN role may assume the PSN role in response to one or more events or conditions (e.g., if the 911-NOW node operating in the PSN role fails, if the 911-NOW node operating in the PSN role is no longer able to perform the PSN role, if a determination is made that the 911-NOW node operating in the SSN role is better able to perform the PSN role than the 911-NOW node currently operating in the PSN role, and the like).

A 911-NOW node operating in the GN role operates as a RN and serves as a gateway to existing network infrastructure (e.g., to external commercial cellular networks, to macro public safety networks, and the like, as well as various combinations thereof). In this role, the access interface(s) of the 911-NOW node is active for communications with user devices 104 and the backhaul interface(s) of the 911-NOW node is active for communications with the existing network infrastructure. A 911-NOW node operating in the GN role may or may not have a mesh interface(s) enabled.

In one embodiment, a 911-NOW node always performs the basic role of RN (with the exception of a 911-NOW node operating in the SN role). In one embodiment, in addition to the RN role, the 911-NOW node may perform one additional role (e.g., either as a GN, PSN, or SSN). In one embodiment, in addition to the RN role, the 911-NOW node may also perform multiple additional roles (e.g., the roles of GN and PSN, or the roles of GN and SSN, and the like).

In other words, a 911-NOW node in the SN role is a standalone node that does not participate in a mesh network (it provides access to user terminals), a 911-NOW node in the RN role is a node that has a mesh interface(s) enabled, and a 911-NOW node in the GN role is a node that has a backhaul interface(s) enabled. A node may operate in both the RN and GN roles at the same time. The roles of PSN and SSN may be made mutually exclusive for reliability purposes.

Thus, a 911-NOW network may be formed of one or more 911-NOW nodes.

If the 911-NOW network includes one 911-NOW node, that 911-NOW node is assigned the SN role (and may wait to discover another 911-NOW node or nodes). The additional 911-NOW nodes(s) may include a 911-NOW node not yet operating in a defined role, a 911-NOW node operating in the SN role, an established 911-NOW network having multiple 911-NOW nodes, and the like, as well as various combinations thereof).

If the 911-NOW network includes two 911-NOW nodes, the roles may be assigned in various ways. For example, one of the 911-NOW nodes may operate in the GN role and the other of the 911-NOW nodes may operate in the PSN role. For example, one of the 911-NOW nodes may operate in both the GN and PSN roles and the other of the 911-NOW nodes may operate in the RN role. Similarly, for example, one of the 911-NOW nodes may operate in both the GN and PSN roles and the other of the 911-NOW nodes may operate in the SSN role. The two 911-NOW nodes may operate using other combinations of roles.

If the 911-NOW network includes three or more 911-NOW nodes, the roles may be assigned in various ways. In one embodiment, one of the 911-NOW nodes is assigned the role of a PSN, another of the 911-NOW nodes is assigned the role of a SSN, and another of the 911-NOW nodes is assigned the role of a GN. In another embodiment, one 911-NOW node is assigned the roles of PSN and GN and another 911-NOW node is assigned the role of SSN. The roles may be assigned in other ways.

A 911-NOW network having a PSN node, a SSN node, and a GN node (as well as any number of other 911-NOW nodes operating as RNs) is referred to herein as an anchored cluster. In one embodiment, an anchored cluster may include only one instance of each of the PSN, SSN, and GN role. In other embodiments, more than one PSN, more than one SSN, and/or more than one GN may be allowed per anchored cluster (e.g., for scalability, load balancing, reliability, and other like purposes).

The NCP module 402 implements the Network Configuration Protocol (NCP), which is used to configure some or all of the 911-NOW nodes of a 911-NOW network. The NCP module 402 may also be referred to herein as an NCP agent (which also may be denoted as a cfgnowd agent).

The NCP protocol is used to configure operational parameters of 911-NOW nodes of a 911-NOW network. In configuring 911-NOW nodes of a 911-NOW network, the NCP protocol may be used to determine configuration information for each of the 911-NOW nodes to be configured and, further, may be used to propagate the configuration information to the 911-NOW nodes to be configured. The parameters configured using the NCP protocol may include any parameters required for the correct operation of the 911-NOW nodes and thus, the sustained operation of the 911-NOW network.

The parameters configured using the NCP protocol may include any parameters required for the 911-NOW node to communicate within the 911-NOW network. The parameters configured using the NCP protocol may also include any parameters required for the 911-NOW node to operate according to the role (or roles) assigned to the 911-NOW node using the RAP protocol. In other words, since each 911-NOW node performs a set of functions and offers certain services within the 911-NOW network (consistent with assigned role(s)), the NCP protocol is used to configure 911-NOW nodes to support such functions and provide such services.

The NCP protocol may be implemented in various different ways. In one embodiment, the NCP protocol operates above the Internet Protocol (IP) layer. In one such embodiment, the NCP protocol may be implemented over a User Datagram Protocol (UDP)/Internet Protocol (IP) connection and, thus, rely on mesh routing to be active in the 911-NOW node running the NCP protocol. In one embodiment, the NCP protocol employs ideas from Internet Engineering Task Force (IETF) Zero Configuration Networking (ZeroConf).

In one embodiment, the NCP protocol is used by a 911-NOW node (denoted as a target 911-NOW node) in order to form a 911-NOW network or join an existing 911-NOW network (which may or may not be an anchored cluster including other 911-NOW nodes operating in GN, PSN, and SSN roles, respectively).

In one such embodiment, the target 911-NOW node listens for advertisements that are periodically transmitted from any 911-NOW node(s) operating in the PSN role (i.e., there may be one or multiple such PSN nodes depending on how many anchored clusters are in the vicinity of the target 911-NOW node). The advertisements from the PSN node(s) are received and rebroadcast by 911-NOW nodes of an anchored cluster (or clusters) which are operating in the RN role and, therefore, the advertisements are eventually propagated to the target 911-NOW node.

In one embodiment, a gateway advertisement includes information that is associated with the anchored cluster (or 911-NOW network, where it is not an anchored cluster) served by the PSN node from which that gateway advertisement is received. For example, a gateway advertisement may include information such as capacity of the 911-NOW network, load on the 911-NOW network, mesh link speeds for link connections between nodes of the 911-NOW network, backhaul link speeds for backhaul connections to existing infrastructure, best available path through the RN node which rebroadcasts the advertisements, an address of the PSN node, and the like, as well as various combinations thereof.

The target 911-NOW node associates with a PSN node (which may require selection of one of multiple available PSN nodes where multiple available 911-NOW networks are present). The selection of one of multiple PSN nodes may be performed using information included in the respective advertisements received from the PSN nodes. For example, the target 911-NOW node may select the PSN node having the best advertised capabilities, the closest PSN node (e.g., based on the shortest hop count path), and the like, as well as various combinations thereof.

The target 911-NOW node begins an NCP session (i.e., also referred to as a configuration session) with the PSN node. The PSN node configures the target 911-NOW node via the NCP session. The PSN node configures the target 911-NOW node using capability information provided from the target 911-NOW node to the PSN node via the NCP session.

The capability information provided from the target 911-NOW node to the PSN node includes information indicative of the capabilities of the target 911-NOW node, information indicative of the environment experienced by the target 911-NOW node, and the like, as well as various combinations thereof. For example, the information provided from the target 911-NOW node to the PSN node may include the number and type(s) of radio interfaces of the target 911-NOW node, the observed environment of the target 911-NOW node (e.g., neighbor 911-NOW nodes visible to the target 911-NOW node in different frequency ranges, observed interference, and the like, as well as various combinations thereof), and any other information which may be used by the PSN node to determine configuration information adapted for configuring the target 911-NOW node.

The PSN node determines configuration information for the target 911-NOW node. The PSN determines the configuration information for the target 911-NOW node using the capability information received from the target 911-NOW node and, optionally, using other information available at the PSN node (or from some other node in the 911-NOW network). The PSN node conveys the configuration information to the target 911-NOW node using the NCP session. The target 911-NOW node receives the configuration information from the PSN node via the NCP session. The target 911-NOW node configures itself using the configuration information received from the PSN node.

The configuration information may include any information which may be used to configure the target 911-NOW node (e.g., parameters to be configured on the target 911-NOW node, information to be stored on the target 911-NOW node, and the like, as well as various combinations thereof). For example, the configuration information may include identifiers (e.g., a new Extended Service Set Identifier (ESSID), addresses for mesh interfaces, frequencies used on mesh interfaces and access interfaces, power levels used on mesh interfaces, addressing schemes and other addressing information, mobility method to be used, and the like, as well as various combinations thereof.

In one embodiment, the target 911-NOW node is authenticated to the PSN node before being configured by the PSN node via the NCP session. The NCP protocol supports an authentication phase in which the cfgnowd agent on the target 911-NOW node performs mutual authentication to the PSN node using security credentials (e.g., digital certificates, symmetric keys stored in tamperproof hardware of the target 911-NOW node, and the like, as well as various combinations thereof). In one embodiment, an Extensible Authentication Protocol (EAP) scheme supporting mutual authentication and dynamic session security keys may be used.

In one embodiment, NCP module 402 may also be adapted to perform configuration of the access node portion of 911-NOW node 400. In another embodiment, depicted in FIG. 4, configuration of the access node portion of 911-NOW node 400 may be performed by a separate Access Configuration (AC) module 403 (which may also be denoted as a bsrcfgd agent).

As depicted in FIG. 4, in one embodiment RAP module 401, NCP module 402 and optional AC module 403 each utilize User Datagram Protocol (UDP)/Internet Protocol (IP) connections (denoted as UDP/IP layer 410) and, thus, rely on mesh routing to be active in the 911-NOW node (denoted as mesh routing layer 411). The mesh routing layer 411 operates via one or more mesh interfaces (denoted as mesh interfaces 412).

In one embodiment, 911-NOW node 400 runs a Node State Vector (NSV). The NSV of a 911-NOW node records dynamic state information parameters associated with the 911-NOW node (e.g., such as node role(s), IP addresses, channel conditions, and the like, as well as various combinations thereof). The NSV of a 911-NOW node is queried by other 911-NOW nodes in order to obtain the dynamic state information parameters, which may then be used executing the Role Assignment Protocol to assign roles to 911-NOW nodes and/or executing the Network Configuration Protocol to configure 911-NOW nodes.

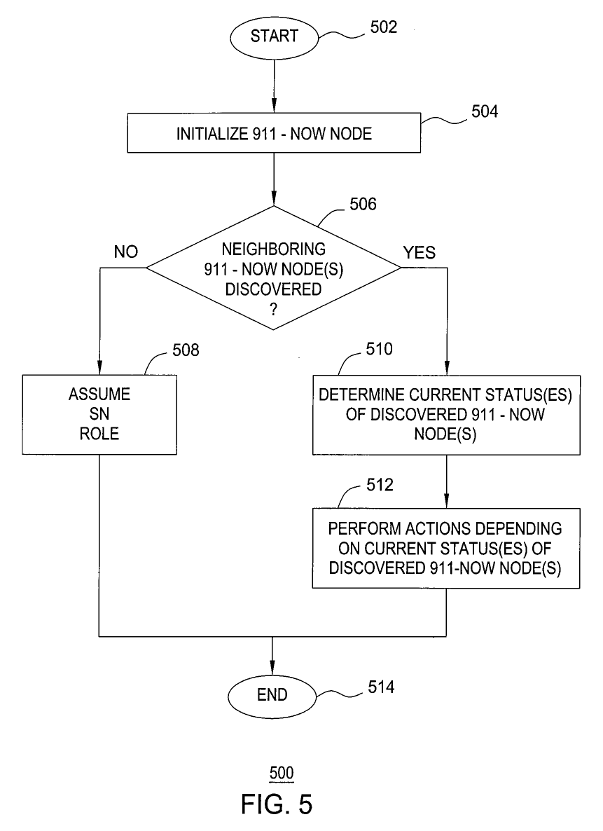

When the 911-NOW node 400 boots, 911-NOW node 410 performs boot-up, configuration, and discovery activities by which it may: (1) determine if there is another 911-NOW node (or nodes) with which it may communicate; and (2) perform activities to form a standalone 911-NOW network, to form a 911-NOW network with one or more other 911-NOW nodes, or to join an existing 911-NOW network, depending on whether or not there is another 911-NOW node with which it may communicate (and, if there is another 911-NOW node, depending on the configuration of that node, including whether it has been assigned a role). The functions performed by a 911-NOW node in preparation for forming a 911-NOW network or joining a 911-NOW network are depicted and described with respect to FIG. 5.

FIG. 5 depicts functions performed by a 911-NOW node in preparation for forming a 911-NOW network or joining a 911-NOW network. Specifically, FIG. 5 depicts functions performed by a 911-NOW node from boot-up of the 911-NOW node through configuration activities performed by the 911-NOW node in order to be able to communicate and discovery activities performed by the 911-NOW node in order to obtain information from which the 911-NOW node may determine which network formation and configuration cases to perform. The functions depicted and described with respect to FIG. 5 are common to all 911-NOW nodes and all NCP/RAP scenarios.

As depicted in FIG. 5, a method according to one embodiment of the present invention (denoted as method 500) is performed, in which a 911-NOW node performs boot-up, configuration and discovery activities. The method 500 of FIG. 5 begins at step 502 and proceeds to step 504.

At step 504, the 911-NOW node is initialized. The 911-NOW node is powered on and boots up. The 911-NOW node sets its state to an initial state (i.e., the current state of the 911-NOW node is set to an initial state which is denoted as INIT). The 911-NOW node activates its mesh interfaces. The 911-NOW node activates the mesh routing protocol in order to enable communication with other nodes. The 911-NOW node activates NCP and RAP.

At step 506, the 911-NOW node determines whether there are any neighboring 911-NOW nodes. The 911-NOW node may determine whether there are any neighboring 911-NOW nodes either passively (e.g., by scanning for beacons from neighboring 911-NOW nodes) or actively (e.g., by probing for neighboring 911-NOW nodes).

In one embodiment, the 911-NOW node determines whether there are any neighboring 911-NOW nodes using the mesh routing protocol. In one such embodiment, the mesh routing protocol may use one or more layer-two mechanisms to scan for neighboring 911-NOW nodes (e.g., scanning for known beacons including known ESSIDs specific to 911-NOW nodes) or to probe for neighboring 911-NOW nodes (e.g., probing requests/responses of neighboring 911-NOW nodes).

CASE I (No neighbor 911-NOW nodes discovered by 911-NOW node that is booting): If no 911-NOW nodes are discovered, method 500 proceeds to step 508. In this case, the 911-NOW node may be the only 911-NOW node at the emergency site, or may be out of range of any other 911-NOW nodes which may be at the emergency site. At step 508, the 911-NOW node assumes the SN role (operating as a standalone GN).

The 911-NOW node activates its backhaul interface(s) and starts any required services (e.g., RADIUS, AAA, SIP conferencing, and the like). The 911-NOW node activates its access interface(s) to support communications for user devices at the emergency site, and assigns subnet addresses. The 911-NOW node leaves its mesh interface(s) active to periodically scan for new neighbor 911-NOW nodes and to respond to queries from new neighbor 911-NOW nodes.

Using this periodic scanning capability, the 911-NOW node may come in contact with one or more other neighboring 911-NOW nodes. When the 911-NOW node comes in contact with another standalone 911-NOW node or an anchored cluster of 911-NOW nodes, the layer-two scanning/probing mechanism detects the neighboring 911-NOW node(s) and performs the appropriate network formation activities, including role assignment activities and node configuration activities.

CASE II (At least one neighbor 911-NOW node discovered by 911-NOW node that is booting): If at least one neighboring 911-NOW node is discovered, the method 500 proceeds to step 510. In this case, the 911-NOW node has discovered at least one other 911-NOW node that is within range at the emergency site; however, the actions taken by the 911-NOW node depend on the status(es) of the discovered 911-NOW node(s). At step 510, the current status of each of the discovered 911-NOW node(s) is determined.

At step 512, the 911-NOW node performs actions depending on the current status of the discovered 911-NOW node(s). The 911-NOW node determines the current status of each discovered 911-NOW node by querying each discovered 911-NOW node to obtain information about the NSVs of each of the discovered 911-NOW nodes. The 911-NOW node queries each of the discovered 911-NOW nodes using the RAP protocol.

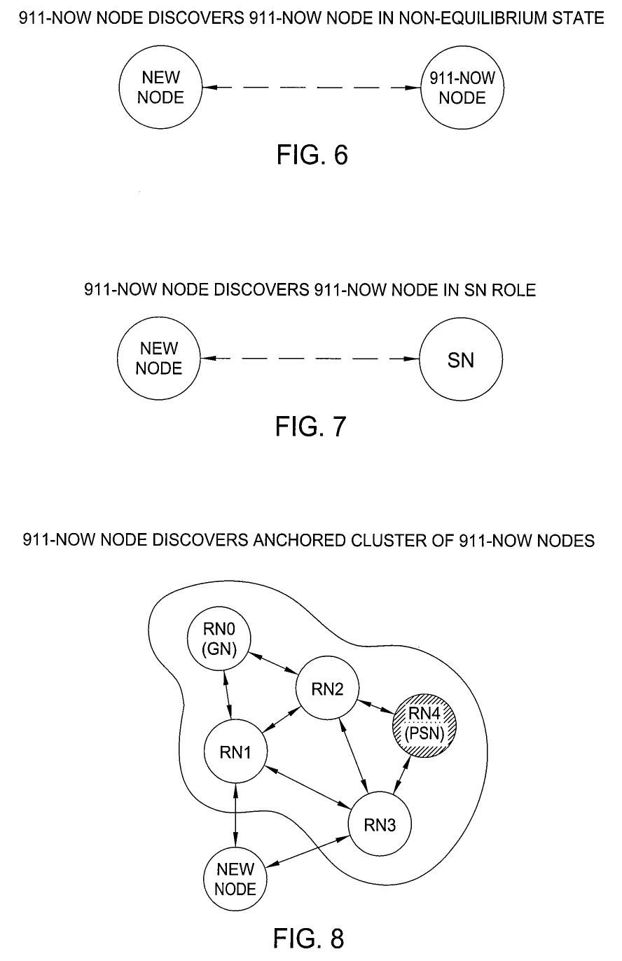

CASE II-a (Discovered 911-NOW node in non-equilibrium state): The discovered 911-NOW node may be a standalone 911-NOW node in a non-equilibrium state. This scenario is most common when an emergency response team arrives at an emergency scene with multiple vehicles and, thus, multiple 911-NOW nodes and the multiple 911-NOW nodes are all in the process of booting at about the same time. This scenario is depicted and described herein with respect to FIG. 6.

CASE II-b (Discovered 911-NOW node standalone and in equilibrium state): The discovered 911-NOW node may be a standalone 911-NOW node operating in an equilibrium state (i.e., operating in a standalone GN role). This scenario may occur when a 911-NOW node arrives at an emergency site at which another 911-NOW node is operating as a standalone GN. This scenario may also occur when one or both of two 911-NOW nodes that are operating as standalone GNs at an emergency site move such that they discover each other. This scenario is depicted and described herein with respect to FIG. 7.

CASE II-a (Discovered 911-NOW node in equilibrium state and part of anchored cluster): The discovered 911-NOW node(s) may be an anchored cluster of 911-NOW nodes. This scenario is most common when a 911-NOW node arrives at an emergency site at which a full 911-NOW network (i.e., an anchored cluster having a GN, a PSN, and a SSN) has already been established. This scenario is depicted and described herein with respect to FIG. 8.

At step 514, method 500 ends. Although depicted and described as ending, it is understood that in such a dynamic environment the 911-NOW node may be reconfigured in response to various events (e.g., as the 911-NOW node or other 911-NOW nodes move at the emergency site, as new 911-NOW nodes arrive at the emergency site, as 911-NOW nodes leave the emergency site as other conditions of the emergency site change, and the like, as well as various combinations thereof).

FIG. 6 depicts an example scenario in which a joining 911-NOW node discovers a 911-NOW node (or 911-NOW nodes) in a non-equilibrium state. A 911-NOW node is determined to be in a non-equilibrium state if the 911-NOW node is executing the NCP and/or RAP protocols in order to establish its role and configuration. The joining 911-NOW node determines that the discovered 911-NOW node is in a non-equilibrium state by querying the discovered 911-NOW node using the RAP protocol in order to obtain information about the current state of the discovered 911-NOW node (e.g., from the NSV of the discovered 911-NOW node).

Upon determining that the discovered 911-NOW node (or nodes) is in a non-equilibrium state, the joining 911-NOW node (i.e., the 911-NOW node that is attempting to form or join a 911-NOW network) may perform one or more of a number of possible actions (at least a portion of which may depend on the exact non-equilibrium state of the discovered 911-NOW node). A description of the possible actions performed by a joining 911-NOW node upon determining that the discovered 911-NOW node (or nodes) is in a non-equilibrium state follows.

If the discovered 911-NOW node(s) is engaged in a RAP session (e.g. as indicated by the NSV of the discovered 911-NOW node), the joining 911-NOW node may attempt to determine the identity of the discovered 911-NOW node(s) that is currently responsible for assigning roles to 911-NOW nodes. If the joining 911-NOW node is able to identify the 911-NOW node responsible for assigning roles, the joining 911-NOW node joins the RAP session and, at the end of the RAP session, all roles will be assigned. If the joining 911-NOW node is unable to identify the 911-NOW node responsible for assigning roles, the joining 911-NOW may proceed to perform one or more other actions.

The joining 911-NOW node may decide to wait for a length of time and then reattempt an NCP session with the discovered 911-NOW node(s). The amount of time that the 911-NOW node waits before reattempting a NCP session with the discovered 911-NOW node(s) may be determined in many ways.

In one embodiment, for example, the joining 911-NOW node queries the discovered 911-NOW node(s) for an expected configuration time (i.e., the amount of time the discovered 911-NOW node expects it will take for the RAP process to be completed such that the discovered 911-NOW node is no longer in a non-equilibrium state). In this embodiment, the joining 911-NOW node may then compute an expected waiting time based on the expected configuration time(s) of the discovered 911-NOW node(s).

In another embodiment, for example, the joining 911-NOW node may use a back-off scheme in which the joining 911-NOW node waits a length of time and then reattempts the NCP configuration session with the discovered 911-NOW node(s). The length of time waited by the joining 911-NOW node may be a random back-off interval or some other interval adapted to control reattempts by a joining 911-NOW node to establish a NCP session with a discovered 911-NOW node.

If the NCP session reattempt leaves the joining 911-NOW node in the same state, the joining 911-NOW node may increase the back-off interval and then reattempt the NCP configuration session with the discovered 911-NOW node(s). The back-off interval may be increased in a number of ways (e.g., such as using binary exponential back-off or some other scheme). In one embodiment, attempts by the joining 911-NOW node to establish an NCP session with the discovered 911-NOW node(s) may be limited (e.g., in terms of the number of back-off reattempts allowed, a maximum back-off interval that is allowed, and the like).

The joining 911-NOW node may decide to become a standalone GN, thereby entering a stable state. In this case, the joining 911-NOW node may periodically check for new neighboring 911-NOW nodes such that the joining 911-NOW node may enter a larger cluster of 911-NOW nodes later. The joining 911-NOW node may decide to enter the standalone GN state for any number of reasons.

For example, the joining 911-NOW node may decide to enter the standalone GN state if the joining 911-NOW node is unable to identify the 911-NOW node responsible for assigning roles, if the joining 911-NOW node is unable to establish a NCP session (either after the first attempt or after subsequent attempts performed using back-off), or even irrespective of any such actions (i.e., without attempting to identify the role assignment node, establish an NCP session, or perform any other actions).

FIG. 7 depicts an example scenario in which a 911-NOW node discovers a 911-NOW node operating in the SN role. In this scenario, we assume that the joining 911-NOW node is also operating in the SN role. The joining 911-NOW node determines that the discovered 911-NOW node is operating in the SN role by querying the discovered 911-NOW node using the RAP protocol in order to obtain information about the current state of the discovered 911-NOW node (e.g., from the NSV of the discovered 911-NOW node).

Upon coming in contact, the two 911-NOW nodes form a mesh network of unauthenticated nodes. Since both 911-NOW nodes are operating as GNs, they perform mutual authentication via an authentication session and then enter into a RAP session in order to reassign their roles. One of the two 911-NOW nodes relinquishes the GN role and instead assumes the RN role. The 911-NOW node which assumes the RN role then begins an NCP session with the GN (and, since the two 911-NOW nodes are already authenticated, the RAN can skip authentication).

In this scenario, the impact of the role reassignment is that the 911-NOW node which changes from the GN role to the RN role deactivates its backhaul interface(s) and forwards any outgoing traffic to the 911-NOW node which retains the GN role. Since this may bring down all external connections, the 911-NOW node which transitions from the GN role to the RN role may take actions to attempt to prevent external connections from being lost as a result of the transition.

In one embodiment, for example, the 911-NOW node which transitions from the GN role to the RN role may transition while continuing to provide services required to support existing external connections (e.g., such as NAT and other services). In another embodiment, for example, the role transition may be delayed in a manner for minimizing the impact of the role transition on external connections (e.g., minimize the number of external connections dropped due to the transition). For example, the role transition may be delayed until a volume of external connections drops below a threshold.

In one embodiment, additional roles may also be assigned to one or both of the 911-NOW nodes. In one embodiment, for example, the node that remains in the GN role may also be assigned the PSN role for performing various services in the formed 911-NOW network (e.g., for authenticating other 911-NOW nodes which may arrive at the 911-NOW network, for configuring other nodes which may arrive at the 911-NOW network, and the like, as well as various combinations thereof). In one embodiment, for example, the node that stands down from the GN role to the RN role may also be assigned the SSN role.

FIG. 8 depicts an example scenario in which a 911-NOW node discovers an anchored cluster of 911-NOW nodes. The joining 911-NOW node identifies an anchored cluster of 911-NOW nodes using NSV information received from each of the neighboring 911-NOW nodes discovered by the joining 911-NOW node. In one embodiment, for example, the joining 911-NOW node identifies an anchored cluster of 911-NOW nodes by determining if any of the neighboring 911-NOW nodes is both operating in the RN role and associated with a 911-NOW node operating in a PSN role or a GN role. The joining 911-NOW node may identify an anchored cluster of 911-NOW nodes in various other ways.

Upon discovering an anchored cluster of 911-NOW nodes, the joining 911-NOW node identifies at least one of the 911-NOW nodes of the anchored cluster that is operating in the PSN role. The joining 911-NOW node obtains the address(es) of the identified 911-NOW node(s) operating in the PSN role. The joining 911-NOW node may obtain the address(es) of the PSN(s) of the anchored cluster in a number of different ways (e.g., by probing the different 911-NOW nodes of the anchored cluster using probing techniques, listening to advertisements broadcasted by 911-NOW nodes of the anchored cluster operating in the GN role, and the like). The joining 911-NOW node associates with a 911-NOW node of the anchored cluster that is operating in the PSN role.

The joining 911-NOW node participates in a role assignment session with existing nodes of the 911-NOW network.

In this scenario, the joining 911-NOW node may be assigned one or more roles. The 911-NOW node may join the 911-NOW network as an RN node. The 911-NOW node may also join the 911-NOW network as a GN node, as a PSN node, as a SSN node, as a GN/PSN node, or as a GN/SSN node. The assignment of such additional roles (i.e., in addition to the RN role) to the joining 911-NOW node may or may not require reassignment of roles of other 911-NOW nodes of the 911-NOW network (depending on which roles have already been assigned in the 911-NOW network).

In one embodiment, the role assigned to the joining 911-NOW node may be assigned in a manner that prevents reassignment of roles to existing 911-NOW nodes of the 911-NOW network. In one such embodiment, for example, since RN0 is already operating in the GN role and RN4 is already operating in the PSN role, the joining 911-NOW node may be assigned the SSN role or may only be assigned the RN role.

In one embodiment, assignment of a role(s) to the joining 911-NOW node may result in a reevaluation of the roles currently assigned to existing 911-NOW nodes of the 911-NOW network.

In one such embodiment, for example, although RN0 is already operating in the GN role, the joining 911-NOW node may be assigned the GN role in response to a determination that the joining 911-NOW node is better suited than RN0 to operate in the GN role. In this case, the joining 911-NOW node is assigned the GN role and RN0 may be assigned a role other than the GN role (e.g., assuming the RN role or possibly one of the other key roles).

In another such embodiment, for example, although RN4 is already operating in the PSN role, the joining 911-NOW node may be assigned the PSN role in response to a determination that the joining 911-NOW node is better suited than RN4 to operate in the PSN role. In this case, the joining 911-NOW node is assigned the PSN role and RN4 may be assigned a role other than the PSN role (e.g., assuming the RN role or possibly one of the other key roles).

Following completion of role assignment, the joining 911-NOW node participates in an NCP session with the PSN node. The PSN node configures the joining 911-NOW node (e.g., by configuring one or more operational parameters of the joining 911-NOW node) via the NCP session. For example, the PSN node may provision parameters such as frequencies to be used on the different radio interfaces, IP addresses for mesh interfaces, IP address ranges for access interfaces, encryption keys, and the like, as well as various combinations thereof. After the joining 911-NOW node is configured by the PSN node, the joining 911-NOW node has joined the cluster.

In addition to such scenarios (i.e., scenarios in which a joining 911-NOW node attempts to form a 911-NOW network or join an existing 911-NOW network), after a joining 911-NOW has formed a 911-NOW network or joined a 911-NOW network, the dynamic nature of the emergency site may result in scenarios in which one or more 911-NOW nodes may be reconfigured or even in which an existing 911-NOW node is reconfigured. The reconfiguration of one or more 911-NOW nodes may include executing a RAP protocol session to reassign roles of some or all of the 911-NOW nodes and/or executing an NCP protocol session to reconfigure operational configurations of some or all of the 911-NOW nodes.

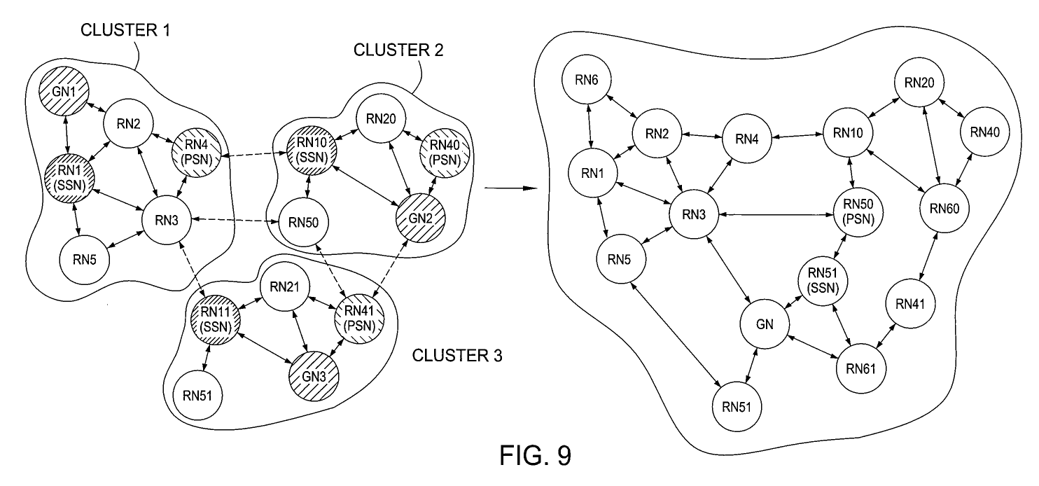

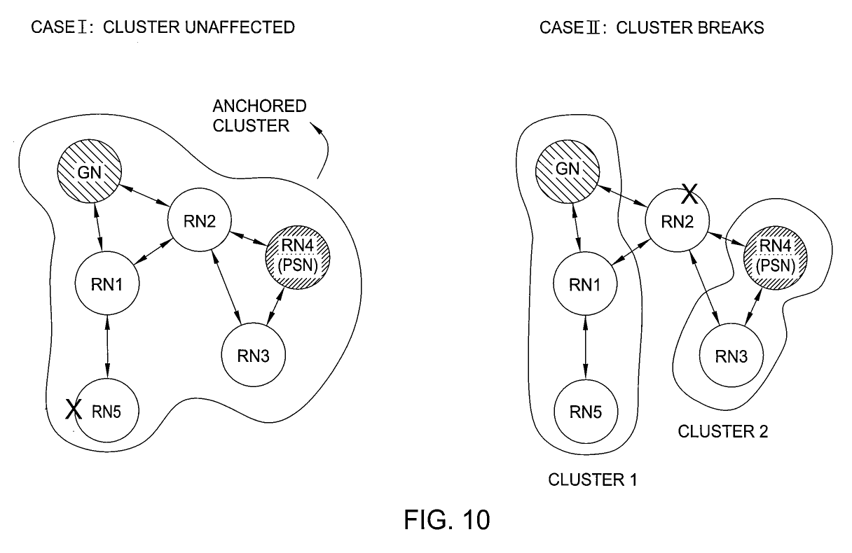

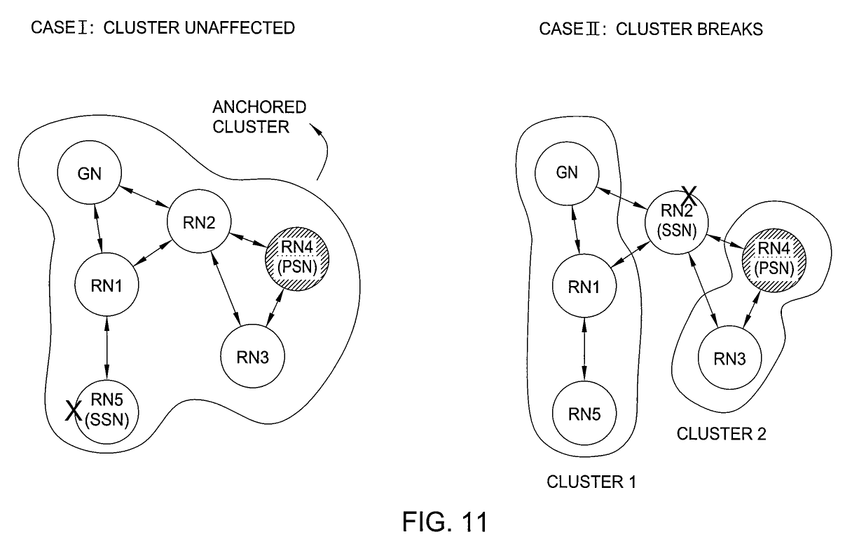

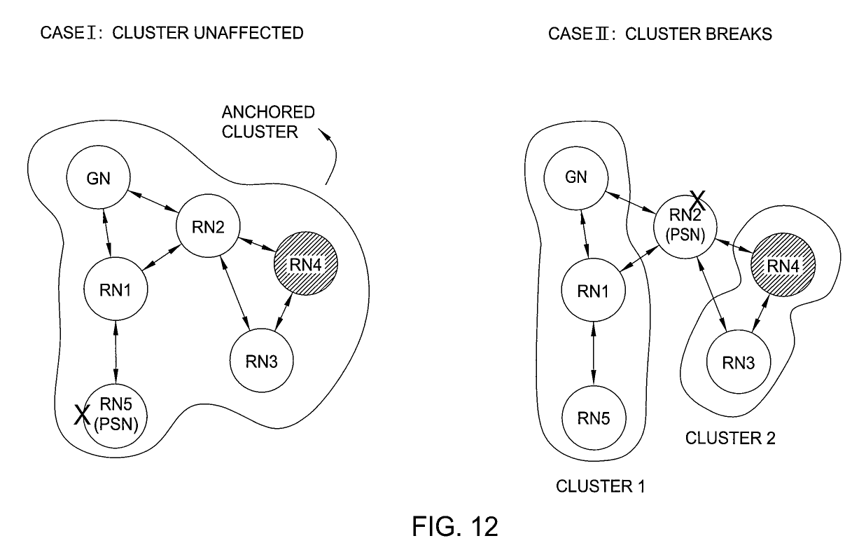

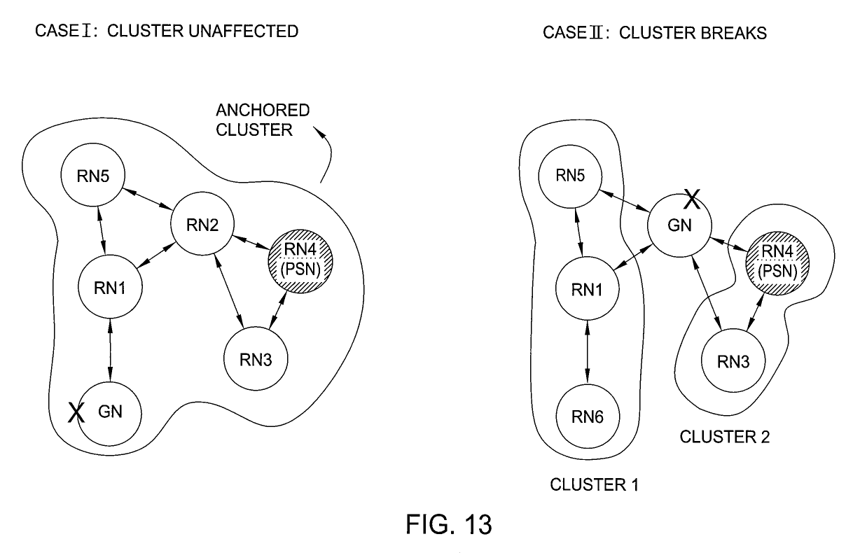

For example, such scenarios may include: (1) when two or more anchored clusters discover each other (depicted and described with respect to FIG. 9); (2) when a 911-NOW node operating in the RN role leaves the 911-NOW network (depicted and described with respect to FIG. 10); (3) when a 911-NOW node operating in the SSN role leaves the 911-NOW network (depicted and described with respect to FIG. 11); (4) when a 911-NOW node operating in the PSN role leaves the 911-NOW network (depicted and described with respect to FIG. 12); and (5) when a 911-NOW node operating in the GN role leaves the 911-NOW network (depicted and described with respect to FIG. 13).

FIG. 9 depicts an example scenario in which two or more anchored clusters discover each other. This scenario may be common when different emergency response teams at a large emergency site operate independently from each other. The emergency response teams may operate independently from each other for many different reasons. For example, the emergency response teams may operate independently from each other because they are operating in different physical areas of the emergency site and/or if the different emergency response teams purposely maintain separate 911-NOW networks at the emergency site.

The different emergency response teams may establish and maintain separate 911-NOW networks for various reasons. For example, different emergency response teams may establish and maintain separate 911-NOW networks based on orders by one or more emergency mission commanders that the 911-NOW network be independent from each other, due to conditions at the emergency site (e.g., lack of good quality links across the emergency site, inefficiencies of forming one large 911-NOW network rather than multiple independent 911-NOW networks, or any other conditions), and the like, as well as various combinations thereof.

As described herein, due to the dynamic nature of the emergency site, even if multiple anchored clusters are initially operating independently of each other, multiple clusters may eventually discover each other (i.e., one or more of the 911-NOW nodes of each anchored cluster come in contact with each other). The multiple anchored clusters may come in contact with each other for various reasons. For example, anchored clusters may come in contact with each other as 911-NOW nodes of the anchored clusters move around the emergency site, in response to a command from a mission commander (i.e., such that independence of 911-NOW nodes of different clusters is not longer maintained), and the like.

As depicted in FIG. 9, an example in which three anchored clusters have discovered each other is described. As depicted in FIG. 9, the three anchored clusters (denoted as cluster one, cluster two, and cluster three) come in contact via multiple 911-NOW nodes. A PSN node of cluster one and a SSN node of cluster two come in contact. A RN node of cluster one and a RN node of cluster two come in contact. That RN node of cluster one and a SSN node of cluster three come in contact. The RN node of cluster two and a GN node of cluster two each come in contact with a PSN of cluster three.

In this scenario, since merging of clusters to form a larger cluster (or clusters) may not always result in optimal operation of the 911-NOW network, the anchored clusters must decide whether to remain separate clusters or to merge to become one anchored cluster. This determination may be performed by determining and evaluating information, such as the lengths of respective network paths to key 911-NOW nodes of the merged cluster that would be formed (e.g., paths to 911-NOW nodes operating in the PSN, SSN, and GN roles), the potential impact on the performance of existing connections and/or future connections which may be supported (e.g., for external connections, mesh connections, and the like), and like information, as well as various combinations thereof.

For example, merger of anchored clusters may result in a cluster having a large number of 911-NOW nodes such that the 911-NOW operating in the PSN role for the merged cluster is unable to serve the large number of 911-NOW nodes. For example, merger of anchored clusters may result in a cluster having a large number of 911-NOW nodes such that the 911-NOW operating in the GN role for the merged cluster is unable to support all of the external connections required by the large number of 911-NOW nodes. The merger of anchored clusters may result in various other negative results.

By contrast, merging of multiple anchored clusters to form a larger cluster (or clusters) may also result in improved performance of the 911-NOW network. For example, where users associated with the different clusters must communicate, merger of the anchored clusters may result an improvement in direct communications between the users of the merged cluster (i.e., because the users are then able to communicate via direct mesh connections between 911-NOW nodes rather than via external connections where the connections must be routed from one cluster out to an external network and then from that external network back into the other cluster). The merger of anchored clusters may result in various other positive results.

In one embodiment, since fully distributed role renegotiations between 911-NOW nodes of multiple clusters may be highly complex, each cluster may appoint one 911-NOW node of the anchored cluster (or at least a subset of the 911-NOW nodes in the anchored cluster) to participate in the role renegotiation with the other clusters. In this embodiment, merging of anchored clusters to form one (or multiple) larger anchored clusters may be serialized into substantially sequential events such that the complexity of performing such merges is manageable. The role renegotiation by which the anchored clusters merge to form a larger anchored cluster may be performed using a RAP session and an NCP session.

If any of the anchored clusters participating in the merge process are not stable (i.e., the 911-NOW nodes of the unstable cluster are involved in a RAP session), 911-NOW nodes of the other anchored clusters participating in the merge process may query neighboring 911-NOW nodes of the unstable cluster to identify the 911-NOW node currently operating as a role assignor node and may then join the RAP session such that all 911-NOW nodes of the anchored clusters are assigned roles for the merged cluster. Following the completion of the RAP session, the roles of GN, PSN, SSN, and RN for all 911-NOW nodes in the merged cluster are assigned (with some 911-NOW nodes relinquishing key roles and other 911-NOW nodes taking on key roles).

For example, 911-NOW nodes RN4, RN 40, and RN41 of clusters one, two, and three, respectively, each relinquish the role of PSN (each operating only in the RN role in the merged cluster). For example, 911-NOW nodes RN1, RN10, and RN 11 of clusters one, two, and three, respectively, each relinquish the role of SSN (each operating only in the RN role in the merged cluster). Additionally, for example, 911-NOW nodes GN1, GN2, and GN3 of clusters one, two, and three, respectively, each relinquish the role of GN (each operating only in the RN role in the merged cluster).

For example, following the formation of the merged cluster, where role reassignment is complete, RN11 which was previously operating in the role of SSN for cluster three is now operating in the GN role for the merged cluster, RN50 which was previously operating in the role of RN for cluster two is now operating in the SSN role for the merged cluster, and RN21 which was previously operating in the RN role for cluster three is now operating in the SSN role for the merged cluster. As described herein, selection of these particular 911-NOW nodes to perform these assigned roles is performed via the RAP session using evaluation of information adapted for use in assigning the roles.

Following completion of role assignment for the merged cluster, the 911-NOW nodes of the merged cluster are then configured using a node configuration (NCP) session. The 911-NOW nodes of the merged cluster that are not operating in the PSN role establish NCP sessions with the 911-NOW operating in the PSN role. The 911-NOW nodes of the merged cluster that are not operating in the PSN role are configured by the 911-NOW operating in the PSN role, via the NCP session. As described herein, the 911-NOW nodes of the merged cluster may be configured based on various parameters (e.g., the respective role(s) assigned to the 911-NOW nodes, information about the 911-NOW network, and the like, as well as various combinations thereof).

FIG. 10 depicts an example scenario in which a 911-NOW node operating in the RN role leaves the 911-NOW network. This scenario typically occurs when the 911-NOW node operating in the RN role loses connectivity to neighboring 911-NOW nodes. A 911-NOW node operating in the RN role may lose connectivity to neighboring 911-NOW nodes for various reasons, such as due to movements of that 911-NOW node (or other neighboring 911-NOW nodes) at the emergency site, events occurring at the emergency site which result in channel loss (e.g., collapsing structures, increased rain, and the like), and the like, as well as various combinations thereof.

In this scenario, the need to perform role reassignment using a RAP session depends on the connectivity graph of the network (i.e., depends on whether the RN node leaving the 911-NOW network causes the 911-NOW network to split into two disconnected clusters).

If the 911-NOW node operating in the RN role is a leaf node in the connectivity graph of the 911-NOW network, no role reassignment needs to be performed. This is denoted as CASE I in FIG. 10.

If the 911-NOW node operating in the RN role is a located at a point within the connectivity graph of the 911-NOW network such that the RN node leaving the 911-NOW network causes the 911-NOW network to split into disconnected clusters, role reassignment needs to be performed immediately because one or more of the disconnected clusters may be missing some or all of the key roles (i.e., GN, PSN, SSN). This is denoted as CASE II in FIG. 10.

As depicted in CASE II of FIG. 10, for example, before the 911-NOW node RN2 leaves the network, the 911-NOW network includes one 911-NOW node operating in the GN role (denoted as GN) and five 911-NOW nodes operating in the RN role (denoted as RN1, RN2, RN3, RN4, and RN5). The 911-NOW node RN4 is also operating in the PSN role for the 911-NOW network. As depicted in CASE II of FIG. 10, the connectivity graph exists as follows: GN is connected to RN1 and RN2; RN1 is connected to RN2 and RN5; RN2 is connected to GN, RN1, RN3, and RN4; RN3 is connected to RN2 and RN 4; and RN 4 is connected to RN2 and RN3.

As depicted in CASE II of FIG. 10, the 911-NOW node RN2 leaves the 911-NOW network. This results in two disconnected clusters. The first disconnected cluster includes the 911-NOW node operating in the GN role and two 911-NOW nodes operating in the RN role (RN1 and RN5). The second disconnected cluster includes two 911-NOW nodes operating in the RN role (RN3 and RN4, which is also operating in the PSN role). Thus, the first cluster is missing a 911-NOW operating in the PSN role and the second cluster is missing a 911-NOW node operating in the GN role.

As a result, a RAP session will be performed within the first cluster in order to assign the role of PSN to either RN1 or RN5 and, similarly, a RAP session will be performed within the second cluster in order to assign the role of GN to RN3. Following execution of the RAP session within each of the disconnected clusters, one or more of each of the 911-NOW nodes in each cluster may then be reconfigured using respective NCP sessions within each of the clusters. Thus, following execution of RAP sessions and NCP sessions, the disconnected clusters will then be self-sufficient clusters.

In this scenario, while the RAP session and the NCP session are being performed within a cluster, communications being supported by each of the 911-NOW nodes before the 911-NOW network is split into disconnected clusters should continue to be supported, if possible, during and after the split of the 911-NOW network into disconnected clusters. Depending on the type of existing connection (e.g., local versus external) and the path of the existing connection, existing local connections may continue to be supported or may be dropped and existing external connections may continue to be supported or may be dropped.

For example, local communications between 911-NOW nodes that still have network paths via mesh routing (i.e., intra-cluster paths) should continue to be supported. As depicted in case 11 of FIG. 10, for example, local communications along a network path from RN1 to RN5 may continue to be supported within the first cluster. By contrast, local communications along a network path from RN1 to RN3 via RN2 may be dropped due to the break in the network path.

For example, external communications between 911-NOW nodes and nodes external to the 911-NOW network should continue to be supported within a cluster that maintains a 911-NOW node operating in the GN role. As depicted in case II of FIG. 10, for example, external communications for external paths for RN1 and RN5 in the first cluster may continue to be supported via GN. By contrast, external communications for external paths for RN3 and RN4 may be dropped due to lack of a 911-NOW node in the second cluster that is operating in the GN role.

FIG. 11 depicts an example scenario in which a 911-NOW node operating in the SSN role leaves the 911-NOW network. The reasons for this scenario are similar to the reasons for the scenario in which a 911-NOW node operating in the RN role leaves the 911-NOW network.

If departure of the 911-NOW node operating in the SSN role does not result in multiple disconnected clusters, a RAP session is performed in order to assign the role of SSN to a different 911-NOW node operating in the RN role and, further, a NCP session is performed to configure the 911-NOW node that assumes the role of SSN for the 911-NOW network. In this case, communications (e.g., local and external communications) of the 911-NOW network are unaffected.

If departure of the 911-NOW node operating in the SSN role does result in multiple disconnected clusters, RAP sessions must be performed in each of the disconnected clusters in order to ensure that each of the key roles (i.e., GN, PSN, SSN) is supported in each of the disconnected clusters. In this case, communications (e.g., local and/or external) within the 911-NOW network may be degraded or even dropped (e.g., depending on various factors as described herein with respect to the scenario in which a 911-NOW node operating in the RN role leaves the 911-NOW network).

FIG. 12 depicts an example scenario in which a 911-NOW node operating in the PSN role leaves the 911-NOW network. The reasons for this scenario are similar to the reasons for the scenario in which a 911-NOW node operating in the RN role leaves the 911-NOW network.

If departure of the 911-NOW node operating in the PSN role does not result in multiple disconnected clusters, the 911-NOW node operating in the SSN role assumes the PSN role and, further, a RAP session is performed in order to assign the role of SSN to a different 911-NOW node. In this case, with the exception of mesh connections that utilized the PSN (which are dynamically rerouted), communications of the 911-NOW network (e.g., local and external communications) are unaffected.

If departure of the 911-NOW node operating in the PSN role does result in multiple disconnected clusters, RAP sessions must be performed in each of the disconnected clusters in order to ensure that each of the key roles (i.e., GN, PSN, SSN) is supported in each disconnected cluster. Additionally, in the disconnected cluster which includes the 911-NOW node operating in the SSN role, the 911-NOW node operating in the SSN role takes over the PSN role and, further, the RAP session that is performed assigns the role of SSN to a different 911-NOW node. In this case, communications (e.g., local and/or external) within the 911-NOW network may be degraded or even dropped (e.g., depending on various factors as described herein with respect to the scenario in which a 911-NOW node operating in the RN role leaves the 911-NOW network).

FIG. 13 depicts an example scenario in which a 911-NOW node operating in the GN role leaves the 911-NOW network. The reasons for this scenario are similar to the reasons for the scenario in which a 911-NOW node operating in the RN role leaves the 911-NOW network.

If departure of the 911-NOW node operating in the GN role does not result in multiple disconnected clusters, a RAP session is performed in order to assign the role of GN to a different 911-NOW node operating in the RN role and, further, a NCP session is performed to configure the 911-NOW node that assumes the role of GN for the 911-NOW network. In the event of assignment of the GN role to a different 911-NOW node, disruption of communications may be reduced by maintaining the same subnet addresses for any RN nodes anchored on the new GN node. In this case, external communications by all nodes of the 911-NOW network is immediately impacted by loss of the GN node, but local communications remain largely unaffected.

If departure of the 911-NOW node operating in the GN role does result in multiple disconnected clusters, RAP sessions must be performed in each of the disconnected clusters in order to ensure that each of the key roles (i.e., GN, PSN, SSN) is supported in each of the disconnected clusters. In the event of assignment of the GN role to a different 911-NOW node, disruption of communications may be reduced by maintaining the same subnet addresses for any RN nodes anchored on the new GN node. In this case, external communications by all nodes of the 911-NOW network is immediately impacted by loss of the GN node, but local communications remain largely unaffected.

In one embodiment, in order to decrease the chances of a 911-NOW network being divided into disconnected components, the RAP protocol may perform role assignment in a manner that attempts to assign the key roles (i.e., GN, PSN, SSN) to 911-NOW nodes that are located at the edge of the 911-NOW network (i.e., to leaf nodes of the connectivity graph of the 911-NOW network).

In one embodiment, in order to decrease the time required to detect a failure of a 911-NOW node operating in the PSN role and to perform a switchover in which a 911-NOW node operating in the SSN role assumes the PSN role, the RAP protocol may perform role assignment in a manner that attempts to ensure that the 911-NOW nodes assigned the roles of PSN and SSN are only one hop away from each other (or at least very close to each other).

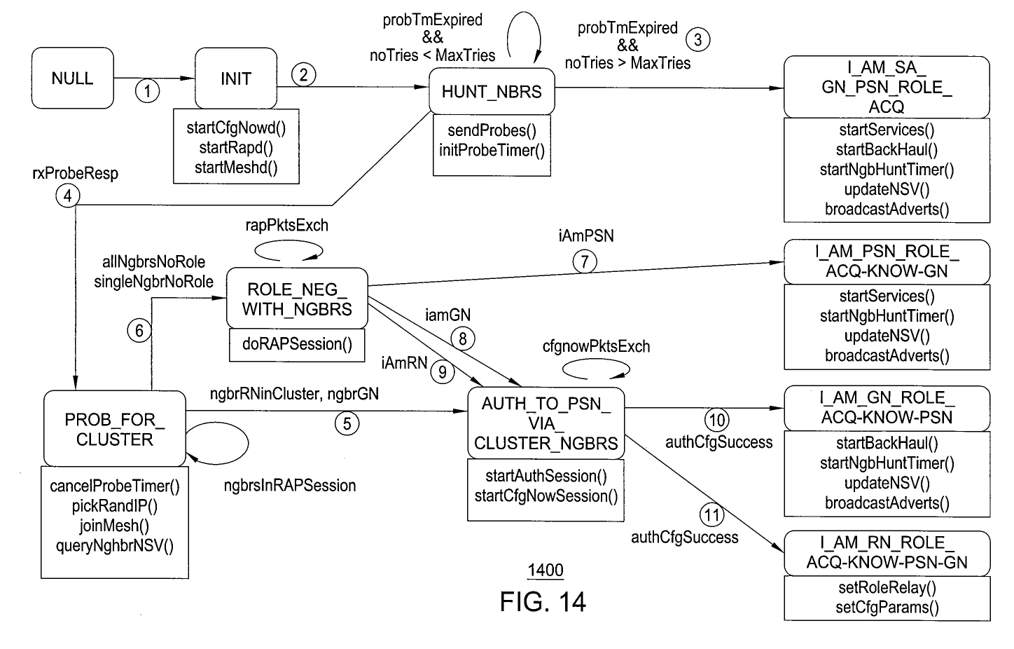

FIG. 14 depicts an exemplary state diagram for a 911-NOW node. The state diagram 1400 of FIG. 14 merely represents one possible implementation of a portion of a state diagram which may be supported by a 911-NOW node. Specifically, state diagram 1400 represents an exemplary portion of a state diagram including specific state transitions supported by a 911-NOW node for a specific combination of node roles.

Thus, the exemplary state diagram may be modified to implement the depicted state transitions for the depicted node roles in various other ways, and, further, the exemplary state diagram may be modified to include various other states and state transitions for various other combinations of node roles which may be supported by 911-NOW nodes.

As depicted in FIG. 14, the 911-NOW node begins in a NULL state. In the NULL state, the 911-NOW node is powered off.

From the NULL state, the 911-NOW transitions to an INIT state (denoted as state transition 1). The 911-NOW node transitions from the NULL state to the INIT state when the 911-NOW node is powered on.

In the INIT state, the 911-NOW node initializes (i.e., boots up). In the INIT state, the 911-NOW node activates the RAP protocol (startRapd( )), activates the NCP protocol (startCfgNowd( )), and activates the mesh interfaces (startMeshd( )). The 911-NOW node may perform other functions in the INIT state.

From the INIT state, the 911-NOW node transitions to a HUNT_NBRS state (denoted as state transition 2). The 911-NOW node transitions from the INIT state to the HUNT_NBRS state when the 911-NOW node is initialized.

In the HUNT_NBRS state, the 911-NOW node is trying to discover whether there are any neighboring 911-NOW nodes within range (i.e., other 911-NOW nodes with which it may form a 911-NOW network). The 911-NOW node may trigger probes (sendProbes( )) which may be used in the 911-NOW node discovery process. The 911-NOW node may also initialize a probe timer (InitProbTimer( )) by which the 911-NOW node determines the length of time for which it should continue to hunt for neighboring 911-NOW nodes before assuming the SN role if no neighboring 911-NOW nodes are discovered.

From the HUNT_NBRS state, depending on one or more conditions, the 911-NOW node may remain in the HUNT_NBRS state, transition to a I_AM_SA_GN_PSN_ROLE_ACQ state (denoted as state transition 3), or transition to a PROB_FOR_CLUSTER state (denoted as state transition 4).

The 911-NOW node remains within the HUNT_NBRS state as long as the 911-NOW node determines that it should continue to attempt to discover neighboring 911-NOW nodes (i.e., that it is still within its allotted time during which it may attempt to discover neighboring 911-NOW nodes).

The 911-NOW node transitions to the I_AM_SA_GN_PSN_ROLE_ACQ state if the 911-NOW node has not identified any neighboring 911-NOW nodes at the end of the allotted time during which the 911-NOW node may attempt to discover neighboring 911-NOW nodes).

The 911-NOW node transitions to the PROB_FOR_CLUSTER state if the 911-NOW node identifies at least one neighboring 911-NOW node before the end of the allotted time during which the 911-NOW node may attempt to discover neighboring 911-NOW nodes.

The 911-NOW node may manage the time that is allotted for discovery of neighboring 911-NOW nodes (i.e., the time during which the 911-NOW node continues to attempt to transition to the PROB_FOR_CLUSTER state) in various ways. In one embodiment, for example, the 911-NOW node manages the allotted time during which the 911-NOW node may attempt to discover neighboring 911-NOW nodes using one or more timers and, optionally, other parameters.

In one embodiment, for example, the 911-NOW node may use a probe timer, a parameter indicative of a number of tries by the 911-NOW node (denoted as noTries), and a parameter indicative of a maximum number of tries allotted to the 911-NOW node (denoted as MaxTries).

In this embodiment, the 911-NOW node will send out a certain number of probe signals attempting to discover neighboring 911-NOW nodes, but if neighboring 911-NOW nodes are not discovered after a certain number of probe signals have been sent (i.e., specified by the maximum number of tries allotted to the 911-NOW node parameter), the 911-NOW node will transition to the I_AM_SA_GN_PSN_ROLE_ACQ state.

As long as the number of probe signals transmitted by the 911-NOW node is not equal to the maximum number of tries allotted to the 911-NOW node (i.e., as long as noTries<MaxTries), if 911-NOW node has not received a reply to a probe signal after the probe timer has expired then the 911-NOW node reattempts discovery of neighboring 911-NOW node. Specifically, the 911-NOW node transmits a new probe signal, restarts the probe timer for the new probe signal, and increments the number of probe signals transmitted by the 911-NOW node (i.e., noTries++).

This process continues until the 911-NOW node discovers neighboring 911-NOW nodes or transitions to a standalone state.

In the I_AM_SA_GN_PSN_ROLE_ACQ state, the 911-NOW node is operating as a standalone node. In one embodiment, as depicted in FIG. 14, although the 911-NOW node is a standalone node, the 911-NOW node may also be operating in the GN role and the PSN role. In other embodiment, as described herein, a 911-NOW node operating in the SN role does not operate in any of the other key roles (i.e., does not operate in the GN, PSN, or SSN roles).

In the I_AM_SA_GN_PSN_ROLE_ACQ state, the 911-NOW node turns on various interfaces, functions, and services. For example, since in this example the 911-NOW node is operating in the GN role, the 911-NOW node turns on its backhaul interfaces (startBackHaul( )). Additionally, the 911-NOW node may start services (startServices( )), update a NSV (updateNSV( )), broadcast advertisements (broadcastAdverts( )), start one or more processes for hunting for neighboring 911-NOW nodes (e.g., startNgbHuntTimer( )), and perform any other required actions.

In the PROB_FOR_CLUSTER state, the 911-NOW interacts with the discovered 911-NOW node(s) in order to determine whether the 911-NOW node will join a cluster operating in the RN role or whether a RAP session is required in order for roles to be assigned. The 911-NOW performs various actions, including canceling the probe timer (cancelProbeTimer( )), selecting an IP address (pickRandIP( )), joining the mesh 911-NOW network of neighbor 911-NOW nodes (joinMesh( )), and querying any neighbor 911-NOW node(s) for state information (queryNghnrNSV( )).

From the PROB_CLUSTER state, the 911-NOW node may remain in the PROB_CLUSTER state, transition to a ROLE_NEG_WITH_NBRS state in which the 911-NOW node participates in a role assignment session with neighboring 911-NOW nodes (denoted as state transition 5), or transition to a AUTH_TO_PSN_VIA_CLUSTER_NGBRS state (denoted as state transition 6).

The 911-NOW node remains in the PROB_FOR_CLUSTER state if the 911-NOW determines that the neighboring 911-NOW nodes are involved in a RAP session (denoted as ngbrsInRAPSession).

The 911-NOW node transitions from the PROB_FOR_CLUSTER state to the ROLE_NEG_WITH_NGBRS state if the 911-NOW node determines that the neighboring 911-NOW node or nodes have not yet been assigned roles and are not currently executing the RAP protocol.

The 911-NOW node transitions from the PROB_FOR_CLUSTER state to the AUTH_TO_PSN_VIA_CLUSTER_NGBRS state if the 911-NOW node determines that the neighboring 911-NOW node is operating in a cluster that includes a 911-NOW node operating as a PSN node.

In the ROLE_NEG_WITH_NGBRS state, the 911-NOW node participates in a RAP session with the neighboring 911-NOW node(s), whereby roles are assigned to the 911-NOW nodes. For example, the 911-NOW node may execute a function in order to invoke the RAP session (i.e., doRAPSession( )). The 911-NOW node exchanges RAP packets (denoted as rapPktsExch) with one or more other 911-NOW nodes. The RAP packets include information which may be used to assign a role(s) to the 911-NOW node(s).

Upon completion of the role assignment using the RAP session, the 911-NOW node is assigned a role. If the 911-NOW node is assigned the PSN role (denoted as iAmPSN), the 911-NOW node transitions from the ROLE_NEG_WITH_NGBRS state to an I_AM_PSN_ROLE_ACQ-KNOW-GN state (denoted as state transition 7, where, in this example this state assumes that there is a GN in the network). If the 911-NOW node is assigned either the GN role (denoted as iAmGN) or the RN role (denoted as iAmRN), the 911-NOW node transitions from the ROLE_NEG_WITH_NGBRS state to the AUTH_TO_PSN_VIA_CLUSTER_NGBRS state (denoted as state transition 8 for the case in which the 911-NOW node is assigned the GN role and denoted as state transition 9 for the case in which the 911-NOW node is assigned the RN role).

In this example, the 911-NOW node is assigned one role, as a PSN node, as a GN node, or as a RN node. Although depicted and described in this example as being assigned only one role (for purposes of clarity), as described herein, in other embodiments the 911-NOW node may be assigned multiple roles (e.g., GN and PSN, GN and SSN, and the like, as well as various combinations thereof).

In the I_AM_PSN_ROLE_ACQ-KNOW-GN state, the 911-NOW node turns on various interfaces, functions, and services. For example, the 911-NOW node may start services (startServices( )), update a NSV (updateNSV( )), broadcast advertisements (broadcastAdverts( )), start one or more processes for hunting for neighboring 911-NOW nodes (e.g., startNgbHuntTimer( )), and perform any other required actions. The 911-NOW node may also perform any 911-NOW services which may be required, such as AAA services, SIP services, communications services (e.g., voice conferences, data exchange, and the like), and the like, as well as various combinations thereof. The 911-NOW node operating in the PSN role provides such 911-NOW services to other 911-NOW nodes of the 911-NOW network.

In the AUTH_TO_PSN_VIA_CLUSTER_NGBRS state, the 911-NOW must authenticate with another 911-NOW node operating in the PSN role before transitioning into the state associated with the role that the 911-NOW node was assigned (i.e., before transitioning into a I_AM_GN_ROLE_ACQ-KNOW-PSN state where the 911-NOW node was assigned the GN role or before transitioning into a I_AM_RN_ROLE_ACQ-KNOW-PSN-GN state where the 911-NOW node was assigned the RN role).

Thus, in the AUTH_TO_PSN_VIA_CLUSTER_NGBRS state, the 911-NOW node starts an authentication session with the 911-NOW node that is operating in the PSN role (denoted as startAuthSession( )). If the 911-NOW node is successfully authenticated, the 911-NOW node transitions from the AUTH_TO_PSN_VIA_CLUSTER_NGBRS state to the state corresponding to the role which was assigned to the 911-NOW node. If the 911-NOW node was assigned to operate in the GN role, the 911-NOW node transitions into the I_AM_GN_ROLE_ACQ-KNOW-PSN state (denoted as state transition 10). If the 911-NOW node was assigned to operate in the RN role, the 911-NOW node transitions into the I_AM_RN_ROLE_ACQ-KNOW-PSN-GN state (denoted as state transition 11).

In the AUTH_TO_PSN_VIA_CLUSTER_NGBRS state, the 911-NOW node may also start an NCP configuration session with the 911-NOW node operating in the PSN role (denoted as startCfgNowSession( )). This is the NCP session by which the 911-NOW node will be configured according to the role that was assigned to the 911-NOW node (assuming that authentication of this 911-NOW node with the 911-NOW node that is operating in the PSN role is successful). The configuration of the 911-NOW node, by the 911-NOW node operating in the PSN role, is performed by exchanging configuration information (denoted as cfgnowPktsExch) between the 911-NOW nodes.

In the I_AM_GN_ROLE_ACQ-KNOW-PSN state, the 911-NOW node turns on various interfaces, functions, and services. For example, the 911-NOW node turns on its backhaul interfaces (startBackHaul( )). The 911-NOW node may also update a NSV (updateNSV( )), broadcast advertisements (broadcastAdverts( )), start one or more processes for hunting for neighboring 911-NOW nodes (e.g., startNgbHuntTimer( )), and perform any other functions which may be performed by a node operating in the GN role. In this state, the 911-NOW node has been authenticated to the 911-NOW node that is operating in the PSN role and has been configured by the 911-NOW that is operating in the PSN role.

In the I_AM_RN_ROLE_ACQ-KNOW-PSN-GN state, the 911-NOW node operates in the RN role. The 911-NOW node sets its role as a relay node for mesh communications in the 911-NOW network (setRoleRelay( )), sets one or more configuration parameters (setCfgParams( )), and may perform one or more other functions. In this state, the 911-NOW node has been authenticated to the 911-NOW node that is operating in the PSN role and has been configured by the 911-NOW that is operating in the PSN role, and thus, knows which 911-NOW node(s) is/are operating in the PSN and GN roles for the 911-NOW network.

Although primarily depicted and described with respect to specific states, state transitions, triggers for the state transitions, functions performed in different states, services provided in different states, and roles supported, it should be noted that the example state diagram depicted and described with respect to FIG. 14 is merely one possible implementation for a state diagram of a 911-NOW node. As such, a 911-NOW node may be implemented using various other state diagrams to support the combination of roles depicted and described with respect to FIG. 14 and, further, may be implemented using various other state diagrams to support various other roles (or combination of roles).

For example, a 911-NOW node may be implemented using various other state diagrams having different states and state transitions for different roles (or combination of roles) to be supported, different functions and/or services to be performed in different roles (or combination of roles), different transitions between roles (or combination of roles), different events which may be supported, (e.g., where a 911-NOW node arrives at a 911-NOW network, where a 911-NOW node leaves a 911-NOW network, merging of different 911-NOW networks to form one or more 911-NOW networks, splitting of a 911-NOW network into multiple 911-NOW networks, and the like), and the like, as well as various combinations thereof.

Although primarily depicted and described herein with respect to a 911-NOW node supporting one state diagram, in other embodiments a 911-NOW node may support multiple state diagrams. In such embodiments, the multiple state diagrams may be implemented in any manner for controlling operation of the 911-NOW node. For example, a 911-NOW node may be implemented using multiple state diagrams in order to support different roles, transitions between different combinations of roles, different events which the 911-NOW node may encounter (e.g., other 911-NOW nodes arriving at or leaving from a 911-NOW network, multiple 911-NOW networks merging to form one 911-NOW network, a 911-NOW network splitting, and the like), and the like, as well as various combinations thereof.

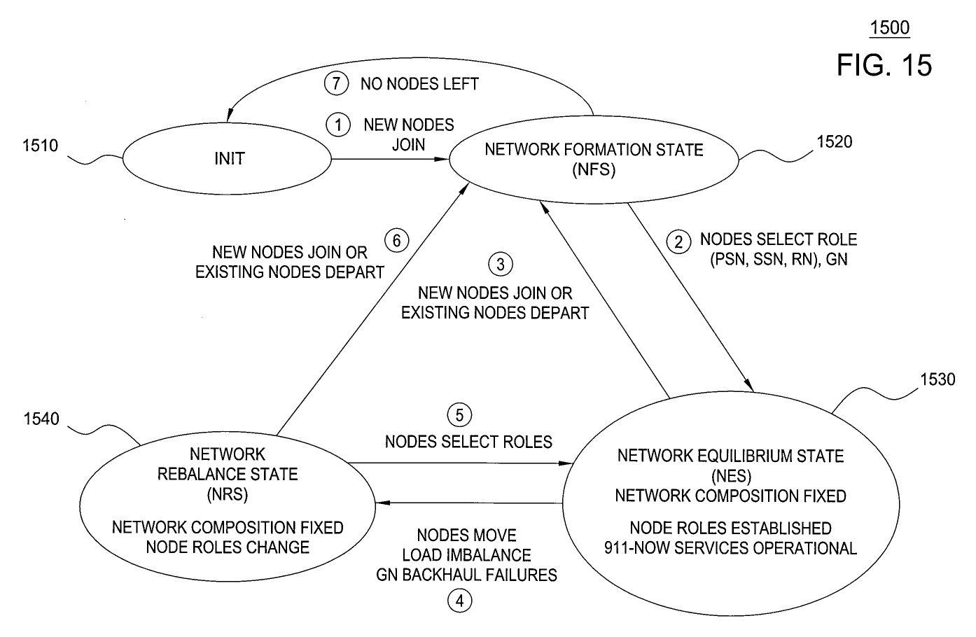

FIG. 15 depicts a network lifecycle of a 911-NOW network supporting network formation and configuration functions of the present invention. As depicted in FIG. 5, in one embodiment, the network lifecycle of the 911-NOW network includes four states: an Initial State (IS) 1510, a Network Formation state (NFS) 1520, a Network Equilibrium state (NES) 1530, and a Network Rebalance state (NRS) 1540.

The 911-NOW network begins in IS 1510. In IS 1510, no 911-NOW nodes are available to form a 911-NOW network. The 911-NOW network remains in IS 1510 as long as no 911-NOW nodes are available to form the 911-NOW network. The 911-NOW network transitions from IS 1510 to NFS 1520 in response to 911-NOW nodes attempting to form a 911-NOW network (denoted as state transition 1).

In NFS 1520, the 911-NOW network performs actions adapted to form a 911-NOW network from the available 911-NOW nodes. Specifically, the 911-NOW network assigns roles to each of the 911-NOW nodes and configures each of the 911-NOW nodes for operation as the 911-NOW network. The available 911-NOW nodes participate in a RAP session by which each of the available 911-NOW nodes may be assigned one or more roles within the 911-NOW network. The role(s) may be assigned using node state information associated with the available 911-NOW nodes. The 911-NOW nodes participate in a NCP session by which each of the available 911-NOW nodes is configured to operate within the 911-NOW network. The 911-NOW nodes may be configured with various parameters.

The 911-NOW network transitions from NFS 1520 to NES 1530 after the 911-NOW network is been formed. More specifically, the 911-NOW network transitions from NFS 1520 to NES 1530 after each of the 911-NOW nodes has been assigned a role (or roles) and each of the 911-NOW nodes has been configured (denoted as state transition 2).

In NES 1530, the 911-NOW network is fully operational. The composition of the 911-NOW network is fixed. The roles of the 911-NOW nodes are established. The 911-NOW nodes are configured according to the established roles. The 911-NOW services are operational for the 911-NOW network, providing a fully functional 911-NOW network.

The 911-NOW network remains in NES 1530, operating as a 911-NOW network, until a condition (or conditions) is detected. A number of different conditions may be detected. The type of condition that is detected determines the network state to which the 911-NOW network transitions in response to the condition.

The 911-NOW network returns from NES 1530 to NFS 1520 in response to any condition or conditions which may impact the composition of the 911-NOW network (denoted as state transition 3). The 911-NOW network returns from NES 1530 to NFS 1520 if an existing 911-NOW node leaves the 911-NOW network, if a new 911-NOW node joins the 911-NOW network, or in response to similar conditions.

The 911-NOW network transitions from NES 1530 to NRS 1540 in response to any condition or conditions which may cause the 911-NOW network to become unbalanced (denoted as state transition 4). For example, the 911-NOW network may transition from NES 1530 to NRS 1540 if an existing 911-NOW node moves within the 911-NOW network, if a load imbalance condition is detected, in response to failure of one or more key nodes and/or associated services of the 911-NOW network (e.g., if backhaul capabilities of the GN node fail, if AM services of the PSN node fail, and the like), or in response to similar conditions.

In NRS 1540, the 911-NOW network undergoes a rebalancing in which the composition of the 911-NOW network is fixed, however, roles currently assigned to the 911-NOW nodes are reevaluated for possible reassignment. The composition of the 911-NOW network is fixed. The reassignment of roles to 911-NOW nodes is performed using the RAP protocol.

The reassignment of roles to 911-NOW nodes may be performed taking into account the condition or conditions which caused the 911-NOW network to transition from NES 1530 to NRS 1540.

For example, where movement of one or more of the 911-NOW nodes causes the 911-NOW network to transition to NRS 1540, the movement of the 911-NOW node(s) may result in degraded channel conditions. For example, assume that the 911-NOW node that is operating in the PSN role moves such that it experiences degraded channel conditions impacting communications with other 911-NOW nodes of the network. In this example, the role of PSN may be reassigned to a different 911-NOW node in the 911-NOW network (and the 911-NOW node previously assigned the role of PSN may be reassigned to operate in the RN role).

For example, where backhaul capability of the 911-NOW node that is operating in the GN role fails, the role of GN may be reassigned to a different 911-NOW node in the 911-NOW network (and the 911-NOW node previously operating in GN role may be reassigned to operate in the RN role).

For example, where a load imbalance is detected in the 911-NOW network, the role(s) of the respective 911-NOW nodes may be reassigned in a manner for correcting the imbalance (or at least reducing it).

Although specific examples of role reassignment in response to specific conditions have been described, various other role reassignments may be performed in response to various other conditions.

When the reassignment of roles to 911-NOW nodes is compete, the 911-NOW network returns from NRS 1540 to NES 1530 (denoted as state transition 5).

As depicted in FIG. 15, since the 911-NOW network environment is dynamic, 911-NOW nodes may arrive at and/or depart from the 911-NOW network while the 911-NOW network is in any of the defined network states.

In one embodiment, in which an existing 911-NOW node leaves the 911-NOW network and/or a new 911-NOW network joins the 911-NOW network while the 911-NOW network is in NES 1530, the 911-NOW network returns from NES 1530 to NFS 1520, at which time roles are assigned to the 911-NOW nodes (denoted as state transition 3).

In one embodiment, in which in an existing 911-NOW node leaves the 911-NOW network and/or a new 911-NOW network joins the 911-NOW network while the 911-NOW network is in NRS 1540, the 911-NOW network returns from NRS 1540 to NFS 1520, at which time roles are assigned to the 911-NOW nodes (denoted as state transition 6).

In one embodiment, in which all existing 911-NOW nodes have left the 911-NOW network, the 911-NOW network returns from NFS 1520 to IS 1510 (denoted as state transition 7). The 911-NOW node no longer exists and will not be formed again until one or more 911-NOW nodes arrive to form another 911-NOW network.

Although primarily depicted and described with respect to specific states and associated state transitions, the 911-NOW network lifecycle may include fewer or more states (as well as different states) and fewer or more (as well as different) associated state transitions.

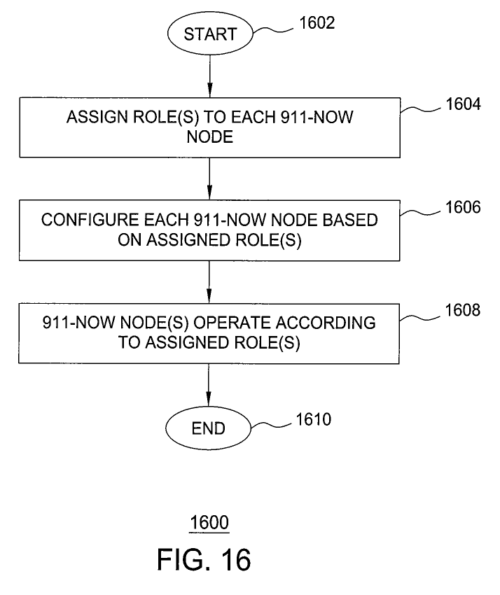

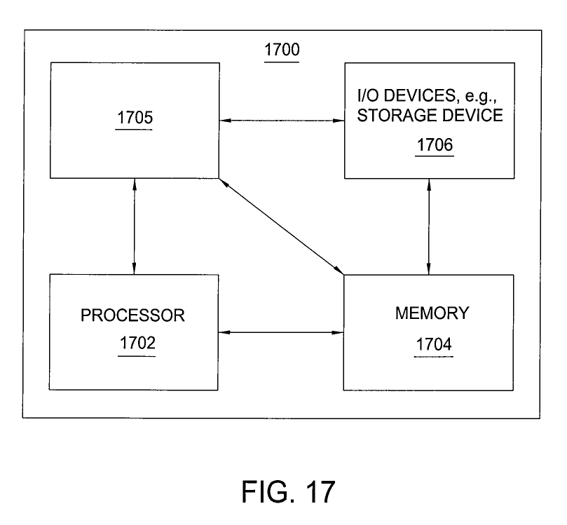

FIG. 16 depicts a method according to one embodiment of the present invention. Specifically, method 1600 of FIG. 16 includes a method for dynamically forming, configuring, and operating a 911-NOW network. Although primarily depicted and described as being performed serially, at least a portion of the steps of method 1600 of FIG. 16 may be performed contemporaneously, or in a different order than depicted and described with respect to FIG. 16. The method 1600 begins at step 1602 and proceeds to step 1604.

At step 1604, at least one role is assigned to each 911-NOW node, thereby forming a 911-NOW network. At step 1606, each 911-NOW node of the 911-NOW network is configured based on the role(s) assigned to that 911-NOW node. At step 1608, the 911-NOW node(s) of the 911-NOW network operate according to the role(s) assigned to the 911-NOW node(s). The operation of the 911-NOW nodes may include providing various functions and services within the 911-NOW network. At step 1610, method 1600 ends. The method 1600 of FIG. 16 may be better understood by reference to FIG. 4-FIG. 15 depicted and described herein.

FIG. 17 depicts a high-level block diagram of a general-purpose computer suitable for use in performing the functions described herein. As depicted in FIG. 17, system 1700 comprises a processor element 1702 (e.g., a CPU), a memory 1704, e.g., random access memory (RAM) and/or read only memory (ROM), a module 1705, and various input/output devices 1706 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, the present process 1705 can be loaded into memory 1704 and executed by processor 1702 to implement the functions as discussed above. Thus, process 1705 (including associated data structures) of the present invention can be stored on a computer readable medium or carrier, e.g., RAM memory, magnetic or optical drive or diskette, and the like.

Although primarily depicted and described herein with respect to using rapidly deployable nodes (such as 911-NOW nodes depicted and described herein) to deploy a wireless network in emergency response situations, rapidly deployable nodes may be used to deploy a wireless network in various other situations. In one embodiment, rapidly deployable nodes may be used in large-crowd environments. For example, rapidly deployable nodes may be deployed during large-crowd events, such as sporting events (e.g., in a city hosting the Super Bowl, in a city hosting the Olympics, and the like), concerts, and the like. In one embodiment, rapidly deployable nodes may be used as a rapid replacement network for commercial cellular networks (i.e., to replace existing network infrastructure while such infrastructure is unavailable). In one embodiment, rapidly deployable nodes may be used in military environments (e.g., to form a rapidly deployable network on the battlefield or in other situations).

Therefore, rapidly deployable nodes according to the present invention are useful for various other applications in addition to emergency response applications, and, thus, may be deployed in various other situations in addition to emergency situations. Thus, the term “emergency site”, which is used herein to denote the geographical location in which one or more rapidly deployable nodes may be deployed to form a wireless network, may be more commonly referred to as a “network site” (i.e., the site at which the rapidly deployable wireless network is deployed to support wireless communications). Similarly, other terms primarily associated with emergency applications may be referred to more generally depending upon the application in which rapidly deployable nodes are deployed. In other words, any number of rapidly deployable nodes according to the present invention may be deployed to any geographical location to form a wireless network for any reason.

It is contemplated that some of the steps discussed herein as software methods may be implemented within hardware, for example, as circuitry that cooperates with the processor to perform various method steps. Portions of the present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast or other signal bearing medium, and/or stored within a working memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method for forming a dynamic wireless network, comprising:
assigning at least one of a plurality of roles to each of at least one wireless node, wherein for each wireless node each of the at least one role assigned to the wireless node is associated with at least one operational parameter of the wireless node; and
configuring each of the at least one wireless node of the dynamic wireless network based on the at least one role assigned to the at least one wireless node.

2. The method of claim 1, wherein the at least one role assigned to each of the at least one wireless node is assigned using a Role Assignment Protocol (RAP).

3. The method of claim 1, wherein each of the at least one wireless node is configured using a Network Configuration Protocol (NCP).

4. The method of claim 1, wherein assigning the at least one role to each of at least one wireless node is performed periodically.

5. The method of claim 1, wherein assigning the at least one role to each of at least one wireless node of the dynamic wireless network is performed in response to an event.

6. The method of claim 5, wherein the event comprises at least one of a wireless node joining the dynamic wireless network, a wireless node leaving the dynamic wireless network, a wireless node moving within the dynamic wireless network, a change of at least one condition of the dynamic wireless network, the dynamic wireless network detecting another dynamic wireless network, and the dynamic wireless network splitting into at least two separate dynamic wireless networks.

7. The method of claim 1, wherein each of the roles comprises a defined role, where each defined role comprises at least one associated function expected to be performed by a wireless node assigned that role.

8. The method of claim 1, wherein the plurality of roles comprises a standalone node (SN) role, a gateway node (GN) role, a primary serving node (PSN) role, a secondary serving node (SSN) role, and a relay node (RN) role.

9. The method of claim 1, further comprising:
exchanging node state information associated with each of the at least one wireless node.

10. The method of claim 9, wherein assigning the at least one role to each of the at least one wireless node is performed using the node state information.

11. The method of claim 9, wherein the node state information comprises at least one of network size information, network connectivity information, channel condition information, addressing information, and existing role information.

12. The method of claim 1, wherein, when at least two wireless nodes are associated with the dynamic wireless network, the step of assigning comprises:
exchanging node state information between each of the at least two wireless nodes; and
executing a role assignment session for the at least two wireless nodes, whereby at least one of the plurality of roles is assigned to each of the at least two wireless nodes.

13. A method for controlling a dynamic wireless network, comprising:
identifying, by a target wireless node, at least one neighbor wireless node;
exchanging node state information with the at least one neighbor wireless node;
participating in a role assignment session whereby at least one of a plurality of roles is assigned to the target wireless node; and
participating in a network configuration session whereby the target wireless node is configured according to the at least one role assigned to the target wireless node.

14. The method of claim 13, wherein the target wireless node identifies the at least one neighbor wireless node from at least one advertisement received from the at least one neighbor wireless node.

15. The method of claim 13, wherein the target wireless node identifies the at least one neighbor wireless node by transmitting at least one probe signal.

16. The method of claim 15, wherein the target wireless node transmits the probe signal in the absence of any advertisements from the at least one neighbor wireless node.

17. The method of claim 13, wherein, in response to a determination that the neighbor wireless nodes are already engaged in a role assignment session, the target wireless node delays participation in the role assignment session.

18. The method of claim 13, wherein the node state information comprises at least one of network size information, network connectivity information, channel condition information, addressing information, and existing role information.

19. The method of claim 13, further comprising:
executing a second role assignment session in response to an event.

20. The method of claim 19, where the event comprises at least one of a wireless node joining the dynamic wireless network, a wireless node leaving the dynamic wireless network, a wireless node moving within the dynamic wireless network, a change of at least one condition of the dynamic wireless network, the dynamic wireless network detecting another dynamic wireless network, and the dynamic wireless network splitting into at least two separate dynamic wireless networks.

21. The method of claim 13, wherein the plurality of roles comprises a gateway node (GN) role, a primary serving node (PSN) role, a secondary serving node (SSN) role, and a relay node (RN) role.

22. The method of claim 13, further comprising:
reassigning at least one role of at least one of the at least one neighbor wireless node during the role assignment session.

23. A method for reconfiguring a dynamic wireless network comprising a plurality of wireless nodes, comprising
detecting that one of the wireless nodes of the dynamic wireless network is no longer available as part of the dynamic wireless network;
determining a role assigned to the unavailable wireless node; and
if the role assigned to the unavailable wireless node comprises a first role type, executing a role assignment session within the dynamic wireless network.

24. A method for determining whether to split a dynamic wireless network comprising a plurality of wireless nodes into at least a first dynamic wireless network and a second dynamic wireless network, comprising:
detecting that one of the wireless nodes of the dynamic wireless network is no longer available as part of the dynamic wireless network;
determining a position of the unavailable wireless node in a connectivity graph of the dynamic wireless network; and
if the unavailable wireless node occupies a first type of position in the connectivity graph of the dynamic wireless network, splitting the dynamic wireless network into at least the first dynamic wireless network and the second dynamic wireless network; or
if the unavailable wireless node occupies a second type of position in the connectivity graph of the dynamic wireless network, determining whether to perform a role assignment session within the dynamic wireless network.

25. A method for merging a first dynamic wireless network comprising a first plurality of wireless nodes and a second dynamic wireless network comprising a second plurality of wireless nodes, comprising:
exchanging node state information between at least one wireless node of the first dynamic wireless network and at least one wireless node of the second dynamic wireless network;
determining, using the node state information, whether to merge the first dynamic wireless network and the second dynamic wireless network; and
in response to a determination to merge the first and second dynamic wireless networks, executing a role assignment session including at least one wireless node of the first dynamic wireless network and at least one wireless node of the second dynamic wireless network, wherein the role assignment session results in reassignment of at least one role of at least one wireless node of the first dynamic wireless network and at least one role of at least one wireless node of the second dynamic wireless network.
